(19) United States
(12) Patent Application Publication
(10) Pub. No.: US 2023/0388165 A1
(43) Pub. Date: Nov. 30, 2023

(54) INFORMATION INDICATION METHOD AND APPARATUS

(71) Applicant: HUAWEI TECHNOLOGIES CO., LTD., Shenzhen (CN)

(72) Inventors: Jian YU, Shenzhen (CN); Wei RUAN, Shanghai (CN); Ming GAN, Shenzhen (CN)

(21) Appl. No.: 18/446,751

(22) Filed: Aug. 9, 2023

Related U.S. Application Data
(63) Continuation of application No. PCT/CN2021/138756, filed on Dec. 16, 2021.

(30) Foreign Application Priority Data
Feb. 10, 2021 (CN) 202110185134.5

(51) Int. Cl. H04L 27/26; H04L 5/00

(52) U.S. Cl. CPC H04L 27/2602; H04L 5/0053

(57) ABSTRACT

A method includes: A first device generates and sends a PPDU, where a first field in a signaling field of the PPDU is in a first value state that indicates that the PPDU carries vendor specific information, and the first value state is indicated by using one or more of the following states: any value state of a disregard bit, a non-default state of a validate bit, a disregard state, and a validate state.

### CROSS-REFERENCE TO RELATED APPLICATIONS

This application is a continuation of International Patent Application No. PCT/CN2021/138756, filed on Dec. 16, 2021, which claims priority to Chinese Patent Application No. 202110185134.5, filed on Feb. 10, 2021. The disclosures of the aforementioned applications are hereby incorporated by reference in their entireties.

### BACKGROUND

The wireless local area network (wireless local area network, WLAN) standard starts from 802.11a/b/g and goes through 802.11n, 802.11ac, and 802.11ax. The WLAN standards define a signaling format of a physical layer protocol data unit (PHY protocol data unit, PPDU). However, in practice, Vendor private design or vendor specific design is performed on the PPDU. As a result, the PPDU carries some vendor specific information. The vendor private design performed on the PPDU conflicts with PPDU information defined in the WLAN standard.

### SUMMARY

Embodiments described herein provide an information indication method and apparatus, a chip, a computer-readable storage medium, a computer program product, and the like, to resolve a problem that vendor private design performed on a PPDU conflicts with PPDU information defined in a WLAN standard.

According to a first aspect, at least one embodiment provides an information indication method. The method is applied to a communication device, or a chip or a chipset in a communication device. The method includes: A first device generates and sends a physical layer protocol data unit PPDU, where a first field in a signaling field of the PPDU is in a first value state, the first value state indicates that the PPDU carries vendor specific information, and the first value state is indicated by using one or more of the following states: any value state of a disregard bit, a non-default state of a validate bit, a disregard state, and a validate state.

In at least one embodiment, one or more states of the any value state of the disregard bit, the non-default state of the validate bit, the disregard state, and the validate state are used as an identifier of the vendor specific information. In other words, in response to the first field in the signaling field of the PPDU being in the first value state, a device that supports a transmission mechanism “The first value state indicates that the PPDU carries the vendor specific information” reads the PPDU in the first value state, and obtain the vendor specific information from the PPDU. The transmission mechanism “The first value state indicates that the PPDU carries the vendor specific information” is referred to as a first transmission mechanism, and details are not described below again. In the foregoing manner, PPDU information defined in an original standard does not conflict with PPDU information defined during vendor privatization customization or subsequent standard improvement.

In at least one embodiment, the first field includes a PPDU type and compression mode subfield and a non-orthogonal frequency division multiple access (orthogonal frequency division multiple access, OFDMA) transmission user quantity subfield. The first value state is indicated by using the following validate state or disregard state: the PPDU type and compression mode subfield indicates single-user transmission, and the non-OFDMA transmission user quantity subfield indicates that a quantity of users participating in non-OFDMA transmission is greater than 1.

In at least one embodiment, that the PPDU type and compression mode subfield indicates single-user transmission, and the non-OFDMA transmission user quantity subfield indicates that the quantity of the users participating in non-OFDMA transmission is greater than 1 is used as the validate state or the disregard state. The PPDU type and the compression mode subfield indicates single-user transmission. A state in which the user quantity of non-OFDMA transmission is indicated to exceed 1 is considered as an identifier of the vendor specific information. A receive end that supports a transmission mechanism “The first value state indicates that the PPDU carries the vendor specific information” determines that the PPDU carries an identifier of the vendor specific information. A corresponding quantity of user fields appear subsequently based on indication of the user quantity of non-OFDMA. The vendor specific information is read from these user fields. A receive end that does not support the transmission mechanism “The first value state indicates that the PPDU carries the vendor specific information” uses, as the validate state or the disregard state, that the PPDU type and compression mode subfield indicates single-user transmission and a non-OFDMA transmission user quantity subfield indicates that the quantity of users participating in non-OFDMA transmission is greater than 1 for processing. In this manner, vendor privatization customization is implemented without changing the PPDU information defined in a WLAN standard.

In at least one embodiment, the vendor specific information is modulation schemes of N spatial streams in an unequal modulation scheme, N is an integer greater than 1, and modulation schemes of at least two of the N spatial streams are different. According to at least one embodiment, the first device identifies the vendor specific information by using the first value state, and add the modulation schemes of the N spatial streams in the unequal modulation scheme to the PPDU.

In at least one embodiment, the non-OFDMA transmission user quantity subfield indicates that a quantity of users is n, n is an integer, and 1<n≤N. The PPDU includes n user fields, where a 1^{st} user field in the n user fields indicates a total number N of the spatial streams, an identifier of a target station, and a modulation scheme of a 1^{st} spatial stream. 2^{nd} to n^{th} user fields indicate modulation schemes of 2^{nd} to N^{th} spatial streams. In at least one embodiment, the non-OFDMA transmission user quantity subfield indicates that the quantity of users is n. The PPDU correspondingly includes the n user fields. Modulation schemes of the N spatial streams is indicated by using the n user fields.

In at least one embodiment, a station identifier subfield in the 1^{st} user field indicates the identifier of the target station. A spatial stream indication subfield in the 1^{st} user field indicates the total number N of the spatial streams. A modulation and coding scheme MCS indication subfield in the 1^{st} user field indicates the modulation scheme of the 1^{st} spatial stream. In at least one embodiment, the 1^{st} user field uses a signaling format of a user field defined in a WLAN standard, so that a change to the WLAN standard is small.

In at least one embodiment, the 2^{nd} to N^{th} spatial streams in the N spatial streams are divided into the K spatial stream groups. The non-OFDMA transmission user quantity subfield indicates that a quantity of users is n, n is an integer, and 1<n≤N. The PPDU includes n user fields, where a 1^{st} user field in the n user fields indicates the total number N of the spatial streams, an identifier of a target station, and a modulation scheme of a 1^{st} spatial stream. 2^{nd} to n^{th} user fields indicate modulation schemes of the K spatial stream groups, where K is an integer, and 1≤K≤N−1.

In at least one embodiment, the N spatial streams are divided into H spatial stream groups, where H is an integer, and 1<H≤N. The non-OFDMA transmission user quantity subfield indicates that a quantity of users is n, n is an integer, and 1<n≤H. The PPDU includes n user fields, where the n user fields include a first user field. The first user field indicates the total quantity H of the spatial stream groups and a number of spatial streams in each of the H spatial stream groups. n−1 user fields in the n user fields other than the first user field indicate a modulation scheme of each of the H spatial stream groups. In at least one embodiment, the first user field indicates grouping information of the spatial streams, so that flexibility of grouping the spatial streams is improved.

In at least one embodiment, a station identifier of the first user field is a specific value.

In at least one embodiment, the N spatial streams are divided into H spatial stream groups, where H is an integer, and 1<H≤N. The non-OFDMA transmission user quantity subfield indicates that a quantity of users is n, n is an integer, and 1<n≤H. The PPDU includes n user fields, where a 1^{st} user field in the n user fields indicates the total quantity H of spatial stream groups, an identifier of a target station, and a modulation scheme of the 1^{st} spatial stream group. 2^{nd} to n^{th} user fields indicate modulation schemes of 2^{nd} to H^{th} spatial stream groups. In at least one embodiment, the non-OFDMA transmission user quantity subfield indicates that the quantity of users is n. The PPDU correspondingly includes the n user fields. Modulation schemes of the H spatial stream groups is indicated by using the n user fields.

In at least one embodiment, the N spatial streams are divided into H spatial stream groups, where H is an integer, and 1<H≤N. The non-OFDMA transmission user quantity subfield indicates that a user quantity is H. The PPDU includes H user fields. An i^{th} user field in the H user fields indicates a modulation scheme of an i^{th} spatial stream group in the H spatial stream groups and a number of spatial streams in each of the H spatial stream groups. i is an integer, and 1≤i≤H. In at least one embodiment, one user field indicates a modulation scheme of one spatial stream group. Therefore, the total quantity H of the spatial stream groups is indicated by using the user quantity indicated by the non-OFDMA transmission user quantity subfield, so that signaling overheads is reduced.

In at least one embodiment, an MCS indication subfield in the i^{th} user field indicates a modulation scheme of the i^{th} spatial stream group. A spatial stream allocation subfield in the i^{th} user field indicates the number of the spatial streams in each of the H spatial stream groups. In at least one embodiment, the user field uses a signaling format that is of a user field used for MU-MIMO user transmission and that is defined in a WLAN standard, so that a change to the WLAN standard is small.

In at least one embodiment, the N spatial streams are divided into H spatial stream groups, where H is an integer, and 1<H≤N. The non-OFDMA transmission user quantity subfield indicates that a user quantity is H. The PPDU includes H user fields. An i^{th} user field in the H user fields indicates a modulation scheme of an i^{th} spatial stream group in the H spatial stream groups and a number of spatial streams in the i^{th} spatial stream group. i is an integer, and 1≤i≤H. In at least one embodiment, one user field indicates a modulation scheme of one spatial stream group. Therefore, the total quantity H of the spatial stream groups is indicated by using the user quantity indicated by the non-OFDMA transmission user quantity subfield, so that signaling overheads is reduced.

In at least one embodiment, an MCS indication subfield in the i^{th} user field indicates a modulation scheme of the i^{th} spatial stream group. A spatial stream indication subfield in the i^{th} user field indicates the number of the spatial streams in the i^{th} spatial stream group. In at least one embodiment, the user field uses a signaling format that is of a user field used for non-MU-MIMO user transmission and that is defined in a WLAN standard, so that a change to the WLAN standard is small.

In at least one embodiment, the non-OFDMA transmission user quantity subfield indicates that a quantity of users is n. The PPDU includes N user fields. A j^{th} user field in the N user fields indicates a modulation scheme of a j^{th} spatial stream of the N spatial streams. j is an integer, and 1≤j≤N.

In at least one embodiment, the first field includes a user field. The first value state is indicated by using a second validate state. The second validate state is that a value of a station identifier subfield in the user field is a specific value. In at least one embodiment, a user field whose station identifier is a specific value is used as an identifier of the vendor specific information.

In at least one embodiment, the first value state is a validate state defined in a WLAN standard. For example, the first value state is one or more validate states defined in the 802.11be standard.

In at least one embodiment, the first value state is also indicated by using a validate state defined in a WLAN standard and a validate bit defined in the WLAN standard. For example, the first value state is indicated by using a validate state and a validate bit defined in the 802.11be standard.

According to a second aspect, at least one embodiment provides an information indication method. The method is applied to a communication device, or a chip or a chipset in a communication device. The method includes: A second device receives a physical layer protocol data unit PPDU, where a first field in a signaling field of the PPDU is in a first value state, and the first value state is indicated by using one or more of the following states: any value state of a disregard bit, a non-default state of a validate bit, a disregard state, and a validate state; in response to the second device supporting a first transmission mechanism, the second device obtains vendor specific information from the PPDU, where the first transmission mechanism is that the first value state indicates that the PPDU carries the vendor specific information; or in response to the second device not supporting a first transmission mechanism, the second device uses the first value state as the validate state or the disregard state to process the PPDU.

In at least one embodiment, one or more states of the any value state of the disregard bit, the non-default state of the validate bit, the disregard state, and the validate state are used as an identifier of the vendor specific information, so that a device supporting the first transmission mechanism reads the PPDU in the first value state, and obtain the vendor specific information from the PPDU. In the foregoing manner, PPDU information defined in an original standard does not conflict with PPDU information defined during vendor privatization customization or subsequent standard improvement.

In at least one embodiment, the first field includes a PPDU type and compression mode subfield and a non-OFDMA transmission user quantity subfield. The first value state is indicated by using the following validate state or disregard state: the PPDU type and compression mode subfield indicates single-user transmission, and the non-OFDMA transmission user quantity subfield indicates that a quantity of users participating in non-OFDMA transmission is greater than 1.

In at least one embodiment, that the PPDU type and compression mode subfield indicates single-user transmission, and the non-OFDMA transmission user quantity subfield indicates that the quantity of the users participating in non-OFDMA transmission is greater than 1 is used as the validate state or the disregard state. The PPDU type and the compression mode subfield indicates single-user transmission. A state in which the user quantity of non-OFDMA transmission is indicated to exceed 1 is considered as an identifier of the vendor specific information. A receive end that supports a transmission mechanism “The first value state indicates that the PPDU carries the vendor specific information” determines that the PPDU carries an identifier of the vendor specific information. A corresponding quantity of user fields appear subsequently based on indication of the user quantity of non-OFDMA. The vendor specific information is read from these user fields. A receive end that does not support the transmission mechanism “The first value state indicates that the PPDU carries the vendor specific information” uses, as the validate state or the disregard state, that the PPDU type and compression mode subfield indicates single-user transmission and a non-OFDMA transmission user quantity subfield indicates that the quantity of users participating in non-OFDMA transmission is greater than 1 for processing. In this manner, vendor privatization customization is implemented without changing the PPDU information defined in a WLAN standard.

In at least one embodiment, the vendor specific information is modulation schemes of N spatial streams in an unequal modulation scheme, N is an integer greater than 1, and modulation schemes of at least two of the N spatial streams are different. According to at least one embodiment, the first device identifies the vendor specific information by using the first value state, and add the modulation schemes of the N spatial streams in the unequal modulation scheme to the PPDU.

In at least one embodiment, the non-OFDMA transmission user quantity subfield indicates that a quantity of users is n, n is an integer, and 1<n≤N. The PPDU includes n user fields, where a 1^{st} user field in the n user fields indicates the total number N of the spatial streams, an identifier of a target station, and a modulation scheme of a 1^{st} spatial stream. 2^{nd} to n^{th} user fields indicate modulation schemes of 2^{nd} to N^{th} spatial streams. In at least one embodiment, the non-OFDMA transmission user quantity subfield indicates that the quantity of users is n. The PPDU correspondingly includes the n user fields. Modulation schemes of the N spatial streams is indicated by using the n user fields.

In at least one embodiment, a station identifier subfield in the 1^{st} user field indicates the identifier of the target station. A spatial stream indication subfield in the 1^{st} user field indicates the total number N of the spatial streams. A modulation and coding scheme MCS indication subfield in the 1^{st} user field indicates the modulation scheme of the 1^{st} spatial stream. In at least one embodiment, the 1^{st} user field uses a signaling format of a user field defined in a WLAN standard, so that a change to the WLAN standard is small.

In at least one embodiment, the 2^{nd} to N^{th} spatial streams in the N spatial streams are divided into the K spatial stream groups. The non-OFDMA transmission user quantity subfield indicates that a quantity of users is n, n is an integer, and 1<n≤N. The PPDU includes n user fields, where a 1^{st} user field in the n user fields indicates the total number N of the spatial streams, an identifier of a target station, and a modulation scheme of a 1^{st} spatial stream. 2^{nd} to n^{th} user fields indicate modulation schemes of the K spatial stream groups, where K is an integer, and 1≤K≤N−1.

In at least one embodiment, the N spatial streams are divided into H spatial stream groups, where H is an integer, and 1<H≤N. The non-OFDMA transmission user quantity subfield indicates that a quantity of users is n, n is an integer, and 1<n≤H. The PPDU includes n user fields, where the n user fields include a first user field. The first user field indicates the total quantity H of the spatial stream groups and a number of spatial streams in each of the H spatial stream groups. n−1 user fields in the n user fields other than the first user field indicate a modulation scheme of each of the H spatial stream groups. In at least one embodiment, the first user field indicates grouping information of the spatial streams, so that flexibility of grouping the spatial streams is improved.

In at least one embodiment, a station identifier of the first user field is a specific value.

In at least one embodiment, the N spatial streams are divided into H spatial stream groups, where H is an integer, and 1<H≤N. The non-OFDMA transmission user quantity subfield indicates that a quantity of users is n, n is an integer, and 1<n≤H. The PPDU includes n user fields, where a 1^{st} user field in the n user fields indicates the total quantity H of spatial stream groups, an identifier of a target station, and a modulation scheme of the 1^{st} spatial stream group. 2^{nd} to n^{th} user fields indicate modulation schemes of 2^{nd} to H^{th} spatial stream groups. In at least one embodiment, the non-OFDMA transmission user quantity subfield indicates that the quantity of users is n. The PPDU correspondingly includes the n user fields. Modulation schemes of the H spatial stream groups is indicated by using the n user fields.

In at least one embodiment, the N spatial streams are divided into H spatial stream groups, where H is an integer, and 1<H≤N. The non-OFDMA transmission user quantity subfield indicates that a user quantity is H. The PPDU includes H user fields. An i^{th} user field in the H user fields indicates a modulation scheme of an i^{th} spatial stream group in the H spatial stream groups and a number of spatial streams in each of the H spatial stream groups. i is an integer, and 1≤i≤H. In at least one embodiment, one user field indicates a modulation scheme of one spatial stream group. Therefore, the total quantity H of the spatial stream groups is indicated by using the user quantity indicated by the non-OFDMA transmission user quantity subfield, so that signaling overheads is reduced.

In at least one embodiment, an MCS indication subfield in the i^{th} user field indicates a modulation scheme of the i^{th} spatial stream group. A spatial stream allocation subfield in the i^{th} user field indicates the number of the spatial streams in each of the H spatial stream groups. In at least one embodiment, the user field uses a signaling format that is of a user field used for MU-MIMO user transmission and that is defined in a WLAN standard, so that a change to the WLAN standard is small.

In at least one embodiment, the N spatial streams are divided into H spatial stream groups, where H is an integer, and 1<H≤N. The non-OFDMA transmission user quantity subfield indicates that a user quantity is H. The PPDU includes H user fields. An i^{th} user field in the H user fields indicates a modulation scheme of an i^{th} spatial stream group in the H spatial stream groups and a number of spatial streams in the i^{th} spatial stream group. i is an integer, and 1≤i≤H. In at least one embodiment, one user field indicates a modulation scheme of one spatial stream group. Therefore, the total quantity H of the spatial stream groups is indicated by using the user quantity indicated by the non-OFDMA transmission user quantity subfield, so that signaling overheads is reduced.

In at least one embodiment, an MCS indication subfield in the i^{th} user field indicates a modulation scheme of the i^{th} spatial stream group. A spatial stream indication subfield in the i^{th} user field indicates the number of the spatial streams in the i^{th} spatial stream group. In at least one embodiment, the user field uses a signaling format that is of a user field used for non-MU-MIMO user transmission and that is defined in a WLAN standard, so that a change to the WLAN standard is small.

In at least one embodiment, the non-OFDMA transmission user quantity subfield indicates that a quantity of users is n. The PPDU includes N user fields. A j^{th} user field in the N user fields indicates a modulation scheme of a j^{th} spatial stream of the N spatial streams. j is an integer, and 1≤j≤N.

In at least one embodiment, the first field includes a user field. The first value state is indicated by using the following validate state or disregard state. The second validate state is that a value of a station identifier subfield in the user field is a specific value. In at least one embodiment, a user field whose station identifier is a specific value is used as an identifier of the vendor specific information.

In at least one embodiment, the first value state is a validate state defined in a WLAN standard. For example, the first value state is one or more validate states defined in the 802.11be standard.

In at least one embodiment, the first value state is also indicated by using a validate state defined in a WLAN standard and a validate bit defined in the WLAN standard. For example, the first value state is indicated by using a validate state and a validate bit defined in the 802.11be standard.

According to a third aspect, at least one embodiment provides an information indication apparatus. The apparatus is a communication device, or is a chip or a chipset in a communication device. The communication device is an access point (access point, AP), or is a station (station, STA). The apparatus includes a processing unit and a transceiver unit. When the apparatus is the communication device, the processing unit is a processor, and the transceiver unit is a transceiver. The apparatus further includes a storage module, and the storage module is a memory. The storage module is configured to store instructions. The processing unit executes the instructions stored in the storage module, to perform the corresponding method in any one of the first aspect. Alternatively, the processing unit executes the instructions stored in the storage module, to perform the corresponding method in any one of the second aspect. When the apparatus is the chip or the chipset in the communication device, the processing unit is a processor, and the transceiver unit is an input/output interface, a pin, a circuit, or the like. The processing unit executes instructions stored in a storage module, to perform the corresponding method in any one of the first aspect. Alternatively, the processing unit executes the instructions stored in the storage module, to perform the corresponding method in any one of the second aspect. The storage module is a storage module (for example, a register or a cache) in the chip or the chipset, or is a storage module (for example, a read-only memory or a random access memory) that is in a network device and that is located outside the chip or the chipset.

According to a fourth aspect, an information indication apparatus is provided, including a processor, a communication interface, and a memory. The communication interface is configured to transmit information, and/or a message, and/or data between the apparatus and another apparatus. The memory is configured to store computer-executable instructions. In response to the apparatus running, the processor executes the computer-executable instructions stored in the memory, so that the apparatus performs the method according to any one of the first aspect, or any one of the second aspect.

According to a fifth aspect, at least one embodiment further provides a computer-readable storage medium. The computer-readable storage medium stores instructions, and in response to the instructions being run on a computer, the computer is enabled to perform the method according to the first aspect, or any one of the second aspect.

According to a sixth aspect, at least one embodiment further provides a computer program product that includes instructions. In response to the computer program product running on a computer, the computer is enabled to perform the method according to the first aspect, or any one of the second aspect.

According to a seventh aspect, at least one embodiment further provides a network system. The network system includes a first device and a second device. The first device performs the corresponding method according to any one of the first aspect, and the second device performs the method according to any one of the second aspect.

According to an eighth aspect, at least one embodiment provides a chip. The chip includes a memory, at least one processor and communication interface. The processor is coupled to the memory, and is configured to read a computer program stored in the memory, to perform the method according to any one of the first aspect, or any one of the second aspect.

According to a ninth aspect, at least one embodiment provides a chip, including a communication interface and at least one processor. The processor runs to perform the method according to any one of the first aspect, or any one of the second aspect.

According to a tenth aspect, at least one embodiment further provides a communication apparatus. The communication apparatus is configured to implement the method according to any one of the first aspect, or any one of the second aspect.

In at least one embodiment, “coupling” indicates a direct combination or an indirect combination of two components.

### BRIEF DESCRIPTION OF DRAWINGS

FIG. 1 is a schematic diagram of an architecture of a WLAN network according to at least one embodiment;

FIG. 2 is a schematic flowchart of an information indication method according to at least one embodiment;

FIG. 3 is a schematic diagram of a format of a PPDU according to at least one embodiment;

FIG. 4A is a schematic diagram of a format of a PPDU according to at least one embodiment;

FIG. 4B is a schematic diagram of a format of a PPDU according to at least one embodiment;

FIG. 5 is a schematic diagram of a signaling format of negotiation information according to at least one embodiment;

FIG. 6 is a schematic diagram of a format of a PPDU according to at least one embodiment;

FIG. 7 is a schematic diagram of a format of a PPDU according to at least one embodiment;

FIG. 8 is a schematic diagram of a format of a special user field according to at least one embodiment;

FIG. 9 is a schematic diagram of a format of a PPDU according to at least one embodiment;

FIG. 10 is a schematic diagram of a format of a PPDU according to at least one embodiment;

FIG. 11 is a schematic diagram of a format of a PPDU according to at least one embodiment;

FIG. 12 is a schematic diagram of a structure of an information indication apparatus according to at least one embodiment; and

FIG. 13 is a schematic diagram of a structure of an information indication apparatus according to at least one embodiment.

### DESCRIPTION OF EMBODIMENTS

To make the embodiments described herein more understandable, the following first explains some descriptions in the embodiments. These explanations shall not be considered as a limitation on the protection scope used by at least one embodiment.

Vendor specific information (vendor specific information): Vendor specific information is information used by vendors for privatization.

Disregard bit, validate bit, disregard state, and validate state: In a WLAN standard, reserved/unused bits (reserved bits) are classified into two types: disregard (Disregard) bit and validate (Validate) bit. Reserved/unused states of a field (or subfield) are classified into two types: disregard state, and validate state.

In response to a PPDU meeting at least one of the following two conditions, the device waits until the PPDU ends, transfer information in a version independent field of the PPDU to a media access control (medium access control, MAC) layer to ensure coexistence, and terminate receiving of the PPDU: (1) A validate bit in the PPDU is not set to a default (or default) value specified in the standard; and (2) values of some subfields in the PPDU are set to a validate state. For a disregard bit or a subfield set to a disregard state, in response to the validate bit of the PPDU being set to the default (or default) value specified in the standard, and there is no subfield set to the validate state, a device ignores the disregard bit, or ignore the subfield set to the disregard state, and continue to read other fields.

For example, in a universal signal field (universal signal field, U-SIG) field of the PPDU, there are five disregard bits and three validate bits. Four disregard bits are included in a U-SIG overflow part of an extreme high throughput signal field (extreme high throughput signal field, EHT-SIG). The validate state exists in joint indication of a PPDU type and compression mode subfield and an uplink/downlink subfield. For example, In response to any one of the validate bits being a non-default value (or a non-default value), the device waits until the PPDU ends, transfer information in the version independent field of the PPDU to the MAC layer, and terminate receiving of the PPDU. For another example, in response to the joint indication of the PPDU type and compression mode subfield and the uplink/downlink subfield being the validate state, the device transfers information in the version independent field of the PPDU to the MAC layer after the PPDU ends, to ensure coexistence and terminate receiving of the PPDU. In response to the validate bit in the PPDU being the default value and there is no subfield set to the validate state, the device ignores the disregard bit or the subfield set to the disregard state, and continue to receive other fields.

Space-time stream (Space-Time Stream) and spatial stream (Spatial Stream): Space-time block coding (space-time block coding, STBC) in different spatial streams and time dimensions is considered for a space-time stream. In response to a transmit end not using STBC, the space-time stream is also referred to as the spatial stream. For ease of description, the space-time stream and the spatial stream are uniformly referred to as the spatial stream in at least one embodiment.

Equal modulation: Equal modulation indicates that modulation schemes of all spatial streams are the same.

Unequal modulation: Unequal modulation indicates that modulation schemes of different spatial streams is different.

To make objectives, technical solution, and advantages of embodiments clearer, the following further describes embodiments in detail with reference to the accompanying drawings.

At least one embodiment is applied to a scenario of a wireless local area network (wireless local area network, WLAN); and is applied to an IEEE 802.11 system standard, for example, an IEEE 802.11ax standard, or a next-generation standard or a further next-generation standard. Alternatively, at least one embodiment is applied to a wireless local area network system, for example, an Internet of things (internet of things, IoT) or an Internet of vehicles (Vehicle to X, V2X). Certainly, at least one embodiment is further applicable to another communication system, for example, a long term evolution (long term evolution, LTE) system, an LTE frequency division duplex (frequency division duplex, FDD) system, an LTE time division duplex (time division duplex, TDD) system, a universal mobile telecommunications system (universal mobile telecommunications system, UMTS), a worldwide interoperability for microwave access (worldwide interoperability for microwave access, WiMAX) communication system, a 5G communication system, and a future communication system such as a 6G communication system.

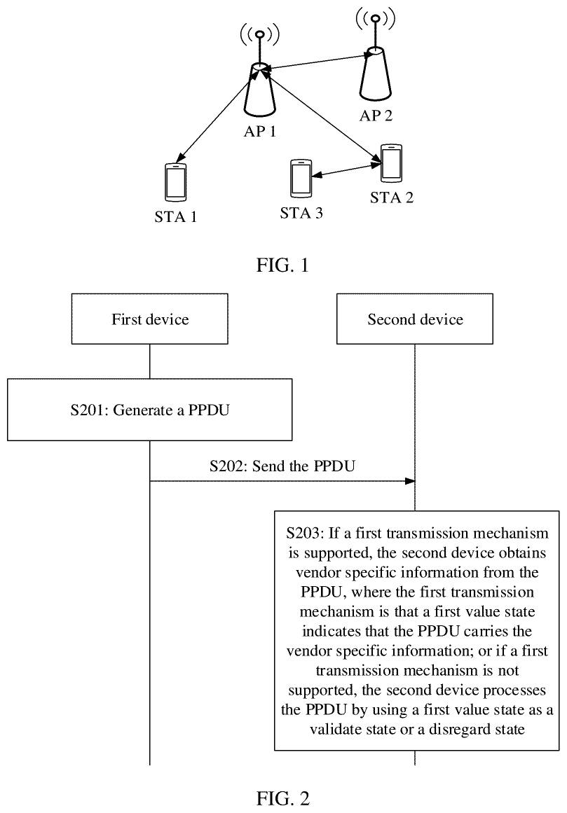

An application scenario of at least one embodiment is communication between an AP and one or more STAs, and is also applicable to communication between APs and communication between STAs. For example, FIG. 1 is a diagram of a network architecture of a WLAN to which embodiments described herein are applicable. In FIG. 1, an example in which the WLAN includes two APs: an AP 1 and an AP 2, a STA 1 and a STA 2 that are associated with the AP 1, and a STA 3 connected to the STA 2 is used. The AP 1 communicates with the STA 1 and the STA 2, the AP 1 and the AP 2 communicates with each other, and the STA 2 and the STA communicates with each other. Quantities of APs and STAs in FIG. 1 are merely an example. There is more or less APs and STAs.

The STA in this embodiment of this application is various user terminals, user apparatuses, access apparatuses, subscriber stations, subscriber units, mobile stations, user agents, user equipment, or the like in another name that have a wireless communication function. The user terminal includes various handheld devices, vehicle-mounted devices, wearable devices, computing devices, or other processing devices connected to a wireless modem that have a wireless communication function; and various forms of user equipment (user equipment, UE), mobile stations (mobile station, MS), terminals (terminal), terminal equipment (terminal equipment), portable communication devices, handheld devices, portable computing devices, entertainment devices, game devices or systems, global positioning system devices or any other proper devices configured to perform network communication by using a wireless medium, and the like. Herein, for ease of description, the devices mentioned above are collectively referred to as stations or STAs.

The AP in this embodiment is an apparatus that is deployed in a wireless communication network and that provides a wireless communication function for a STA associated with the AP. The AP is used as a hub of the communication system, and is a communication device such as a base station, a router, a gateway, a repeater, a communication server, a switch, or a bridge. The base station includes various forms of macro base stations, micro base stations, relay stations, and the like. Herein, for ease of description, the devices mentioned above are collectively referred to as access points APs. Specifically, the AP and the STA in at least one embodiment is an AP and a STA to which an IEEE 802.11 system standard is applicable.

In at least one embodiment, “at least one” means one or more, and “a plurality of” means two or more. The term “and/or” describes an association relationship between associated objects and indicates that three relationships exist. For example, A and/or B indicates the following three cases: Only A exists, both A and B exist, and only B exists. A and B each is singular or plural. The character “/” generally indicates an “or” relationship between the associated objects. At least one of the following items (pieces) or a similar expression thereof refers to any combination of these items, including any combination of singular items (pieces) or plural items (pieces). For example, at least one of a, b, or c indicates a, b, c, a and b, a and c, b and c, or a, b, and c, where a, b, and c is singular or plural.

In addition, unless otherwise stated, ordinal numbers such as “first” and “second” in at least one embodiment are used to distinguish between a plurality of objects, and are not intended to limit sizes, content, an order, a time sequence, priorities, or importance degrees of the plurality of objects. For example, a first data packet and a second data packet are merely names given for ease of description, and the two data packets is a same data packet, or is different data packets.

The following describes in detail at least one embodiment with reference to the accompanying drawings.

At least one embodiment provides an information indication method. The method is applied to a WLAN system, for example, the WLAN system shown in FIG. 1. As shown in FIG. 2, the method includes the following steps.

S201: A first device generates a PPDU, where a first field in a signaling field of the PPDU is in a first value state, the first value state indicates that the PPDU carries vendor specific information, and the first value state is indicated by using one or more of the following states: any value state of a disregard bit, a non-default state of a validate bit, a disregard state, and a validate state.

For example, the vendor specific information includes but is not limited to: modulation schemes of N spatial streams in an unequal modulation scheme, where modulation schemes of at least two of the N spatial streams are different, and N is an integer greater than 1; HARQ information; information indicating AP coordination; and the like. Vendors can design the vendor specific information based on usage, which is not listed here.

The first field includes one or more fields. This is not limited in at least one embodiment.

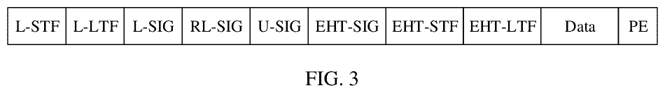

Optionally, the PPDU is in a format of an extreme high throughput multiple user physical layer protocol data unit (extreme high throughput multiple user physical layer protocol data unit, EHT MU PPDU). For example, as shown in FIG. 3, the PPDU includes a preamble part, a data (Data) field, and data packet extension (packet extension, PE). The preamble part includes a legacy preamble, for example, a legacy short training field (legacy short training field, L-STF), a legacy long training field (legacy long training field, L-LTF), or a legacy signaling field (legacy signaling field, L-SIG). The legacy preamble can ensure coexistence of a new device and a legacy device. The L-SIG includes a length field, and indirectly indicates duration of a field following the L-SIG in the PPDU. In addition, the L-SIG further includes repetition of the legacy signaling field, to enhance reliability of the legacy signaling field. In addition, the L-SIG further provides features that enable a receive end to detect whether two symbols are the same, a remainder of a length in the L-SIG, and the like, so that the receive end identifies that the PPDU is an EHT PPDU.

Optionally, the preamble part further includes a repeat legacy signaling field (repeat legacy signaling field, RL-SIG). The RL-SIG is an RL-SIG field defined in the 802.11ax.

In addition, the preamble part further includes U-SIG, and the U-SIG indicates version information of the PPDU. If the PPDU is the EHT MU PPDU, the EHT-SIG is further present after the U-SIG. The U-SIG and the EHT-SIG carries signaling information for demodulating a subsequent data field.

As shown in Table 1, the following describes an example of a U-SIG overflow (Overflow) subfield in a common part of the U-SIG and the EHT-SIG.

TABLE 1

| Field | Category | Subfield | Bit | Description |
|---|---|---|---|---|
| U- | Version | Physical layer version | 3 | Indicate a version of a PPDU |
| SIG | independent | identifier (version | | |
| | (version | identifier) subfield | | |
| | independent) | PPDU bandwidth | 3 | Indicate a bandwidth of a PPDU |
| | | (bandwidth, BW) | | |
| | | subfield | | |
| | | Uplink (uplink, | 1 | Uplink/Downlink indication |
| | | UL)/Downlink | | |
| | | (downlink, DL) | | |
| | | subfield | | |
| | | Basic service set color | 6 | Indicate a color identifier of a |
| | | (BSS color) subfield | | basic service set (basic service |
| | | | | set, BSS) in which a cell is |
| | | | | located, which is equivalent to |
| | | | | identification information of the |
| | | | | cell |
| | | Transmit opportunity | 7 | Indicate a transmit opportunity |
| | | (TXOP) subfield | | (transmit opportunity, TXOP) |
| | Version dependent | Disregard (disregard) | 5 | Disregard-reserved bit |
| | (version | bit | | |
| | dependent) | Validate (validate) bit | 1 | Validate-reserved bit, where a |
| | | | | default value is 1 |
| | | Punctured channel | 5 | Indicate a punctured channel |
| | | indication (punctured | | |
| | | channel indication) | | |
| | | subfield | | |
| | | Validate (validate) bit | 1 | Validate-reserved bit, where a |
| | | | | default value is 1, and is used as |
| | | | | extension of punctured channel |
| | | | | indication |
| | | PPDU type and | 2 | Indicate a PPDU type and a |
| | | compression mode | | compression mode |
| | | (PPDU type and | | |
| | | compression mode) | | |
| | | subfield | | |
| | | Validate bit | 1 | Validate-reserved bit, where a |
| | | | | default value is 1, and is used as |
| | | | | extension of a PPDU type and a |
| | | | | compression mode |
| | | EHT-SIG modulation | 2 | Indicate a modulation and coding |
| | | and coding scheme | | scheme of an EHT-SIG |
| | | (EHT-SIG MCS) | | |
| | | subfield | | |
| | | Number of EHT-SIG | 5 | Indicate a number of EHT-SIG |
| | | symbols (number of | | symbols |
| | | EHT-SIG symbols) | | |
| | | subfield | | |
| | Cyclic redundancy | CRC in U-SIG (CRC | 4 | Used to check U-SIG information |
| | check (cyclic | in U-SIG) | | |
| | redundancy check, | Tail in U-SIG (tail in | 6 | Tail bit, used to end coding |
| | CRC) & tail bit | U-SIG) | | |
| | (tail) | | | |
| EHT- | Version dependent | Spatial reuse (spatial | 4 | Spatial reuse |
| SIG | (version | reuse) subfield | | |
| | dependent) (U- | Guard interval + long | 2 | Indicate a guard interval (guard |
| | SIG overflow) | training field size | | interval, GI) and a long training |
| | | (size) subfield | | field (long training field, LTF) |
| | | | | size |
| | | Number of EHT-LTF | 3 | Indicate a number of EHT-LTF |
| | | symbols (Number of | | symbols |
| | | EHT-LTF symbols) | | |
| | | subfield | | |
| | | LDPC extra symbol | 1 | Indicate whether an extra symbol |
| | | segment (LDPC extra | | segment is transmitted after low |
| | | symbol segment) | | density parity check (low density |
| | | subfield | | parity check, LDPC) coding |
| | | Pre-FEC padding | 2 | Indicate a pre-forward error |
| | | (Pre-FEC padding) | | Correction (Forward Error |
| | | subfield | | Control, FEC) padding factor |
| | | PE disambiguity | 1 | Indicate whether data packet |
| | | (disambiguity) | | extension is ambiguous |
| | | subfield | | |
| | | Disregard (disregard) | 4 | Disregard-reserved bit |
| | | bit | | |

The following describes an example of the uplink/downlink subfield and the PPDU type and compression mode subfield in a U-SIG field, as shown in Table 2.

TABLE 2

| | | Description | | | | |
|---|---|---|---|---|---|---|
| | | | | Whether a | | |
| | | | | resource | | |
| U-SIG field | | | | unit | | |
| | PPDU type | | | allocation | Quantity | |
| | and | | Whether | indication | of users | |
| | compression | | EHT-SIG | subfield | in a | |
| Uplink/Downlink | mode | PPDU type | exists? | exists? | PPDU | Note |
| 0 (downlink) | 0 | EHT MU | Yes | Yes | ≥1 | DL OFDMA, |
| | | | | | | including non- |
| | | | | | | multiple user |
| | | | | | | multiple input |
| | | | | | | multiple |
| | | | | | | output |
| | | | | | | (multiple user |
| | | | | | | multiple input |
| | | | | | | multiple |
| | | | | | | output, MU- |
| | | | | | | MIMO) and |
| | | | | | | MU-MIMO |
| | 1 | EHT MU | Yes | No | 1 | Single user |
| | | | | | | (single user, |
| | | | | | | SU) or null |
| | | | | | | data packet |
| | | | | | | (null data |
| | | | | | | packet, NDP) |
| | | | | | | (not sent to an |
| | | | | | | access point |
| | | | | | | AP, usually |
| | | | | | | refers to |
| | | | | | | downlink) |
| | 2 | EHT MU | Yes | No | >1 | DL MU- |
| | | | | | | MIMO (non- |
| | | | | | | OFDMA |
| | | | | | | transmission) |
| | 3 | — | — | — | — | Validate state |
| 1 (uplink) | 0 | EHT TB | No | — | ≥1 | UL OFDMA |
| | | (trigger | | | | (including |
| | | based, | | | | non-MU- |
| | | based on | | | | MIMO and |
| | | triggering) | | | | MU-MIMO) |
| | 1 | EHT MU | Yes | No | 1 | SU or NDP |
| | | | | | | (sent to an AP, |
| | | | | | | that is, uplink) |
| | 2-3 | — | — | — | — | Validate state |

Optionally, in addition to the U-SIG overflow (Overflow) subfield, the EHT-SIG further includes another field. For example, fields included in the EHT-SIG is shown in Table 3.

TABLE 3

| Field | Category | Subfield | Bit | Description |
|---|---|---|---|---|
| EHT- | Version | U-SIG overflow | Refer to table 1 | |
| SIG | dependent | | | |
| | (version | | | |
| | dependent) | | | |
| | Common part of | Quantity of non- | 3 | Indicate the quantity of users |
| | the EHT-SIG | OFDMA | | participating in non-OFDMA |
| | other than U- | transmission users | | transmission, which is set to 0 during |
| | SIG overflow | | | single-user transmission, indicating one |
| | | | | user |
| | User field for | Station identifier | 11 | Indicate identifier information of a |
| | non-MU-MIMO | | | station |
| | transmission | Modulation and | 4 | Indicate a modulation and coding |
| | | coding scheme | | scheme |
| | | | | 0: binary phase shift keying (binary |
| | | | | phase shift keying, BPSK), bit rate (rate, |
| | | | | R) = 1/2 |
| | | | | 1: quadrature phase shift keying |
| | | | | (quadrature phase shift keying, QPSK), |
| | | | | R = 1/2 |
| | | | | 2: QPSK, R = 3/4 |
| | | | | 3: 16-quadrature amplitude modulation |
| | | | | (quadrature amplitude modulation, |
| | | | | QAM), R = 1/2 |
| | | | | 4: 16-QAM, R = 3/4 |
| | | | | 5: 64-QAM, R = 2/3 |
| | | | | 6: 64-QAM, R = 3/4 |
| | | | | 7: 64-QAM, R = 5/6 |
| | | | | 8: 256-QAM, R = 3/4 |
| | | | | 9: 256-QAM, R = 5/6 |
| | | | | 10: 1024-QAM, R = 3/4 |
| | | | | 11: 1024-QAM, R = 5/6 |
| | | | | 12: 4096-QAM, R = 3/4 |
| | | | | 13: 4096-QAM, R = 5/6 |
| | | | | 14: BPSK, dual-carrier modulation, |
| | | | | repetition, R = 1/2 |
| | | | | 15: BPSK, dual-carrier modulation, |
| | | | | R = 1/2 |
| | | Reserved | 1 | Reserved, where a default value is 1 |
| | | | | In response to a station identifier beomg |
| | | | | matched, this field is a validate field. |
| | | | | In response to a station identifier being |
| | | | | not matched, this field is a disregard |
| | | | | field. |
| | | NSS | 4 | Indicate a number of spatial streams |
| | | Beamforming | 1 | Indicate whether beamforming is used. |
| | | (beamformed) | | |
| | | Coding (Coding) | 1 | Indicate whether a coding scheme is |
| | | | | binary convolution code (binary |
| | | | | convolution code, BCC) or low density |
| | | | | parity check (low density parity check, |
| | | | | LDPC) code |
| | CRC & tail | CRC | 4 | Used to check the common part and a |
| | | | | user field in the EHT-SIG |
| | | Tail | 6 | Tail bit, used to end coding |

Optionally, the quantity of the non-OFDMA transmission users is also a subfield of the U-SIG overflow field.

The subfields included in the EHT-SIG and the corresponding quantities of bits shown in Table 3 are merely examples for description, and are not specifically limited.

The preamble part further includes an extreme high throughput short training field (extreme high throughput short training field, EHT-STF) and an extreme high throughput long training field (extreme high throughput long training field, EHT-LTF). In the preamble part, the EHT-STF is used for automatic gain control, and the EHT-LTF is used for channel estimation.

The data packet extension provides more time for a receiver to process data.

S202: The first device sends the PPDU. Correspondingly, a second device receives the PPDU.

S203: In response to the second device supporting a first transmission mechanism, the second device obtains the vendor specific information from the PPDU, where the first transmission mechanism is that the first value state indicates that the PPDU carries the vendor specific information; or in response to the second device not supporting a first transmission mechanism, the second device processes the PPDU by using the first value state as the validate state or the disregard state.

In response to the second device supporting the transmission mechanism “The first value state indicates that the PPDU carries the vendor specific information”, the second device determines, when the PPDU is in the first value state, that the PPDU carries the vendor specific information, and obtain the vendor specific information. In response to the second device not supporting the transmission mechanism “The first value state indicates that the PPDU carries the vendor specific information”, the second device cannot read the PPDU in the first value state, and therefore cannot obtain the vendor specific information. To be specific, a value state (that is, the first value state) of the first field in the PPDU signaling field indicates whether the PPDU carries the vendor specific information. In response to the second device supporting the mechanism in which the first value state indicates that the PPDU carries the vendor specific information, after receiving the PPDU, the second device finds that the first field of the PPDU is in the first value state. In this way, the second device considers that the PPDU carries the related vendor specific information, and obtains the vendor specific information. On the contrary, in response to the second device not supporting the mechanism in which the first value state indicates that the PPDU carries the vendor specific information, after receiving the PPDU, the second device finds that the first field of the PPDU is in the first value state. In this way, the second device cannot read the PPDU, and therefore cannot obtain the vendor specific information.

The validate state or the disregard state indicates the first value state, and the first value state is also used as an identifier of the vendor specific information. For a device that supports such vendor specific information, the first value state is not processed as the validate state or the disregard state, but specific vendor specific information is further acquired based on the first value state. For a device that does not support such vendor specific information, the first value state is used as the validate state or the disregard state, that is, receiving of the PPDU is terminated, or a field of the disregard state is ignored, and other fields are further read.

Optionally, before step S202, the first device and the second device exchange information, to determine whether the peer party supports or does not support the first transmission mechanism. For example, the first device and the second device interact in an association phase. For example, the STA sends an association request frame, where the association request frame includes indication indicating whether the STA supports the first transmission mechanism. The AP sends an association response frame, where the association response frame includes indication indicating whether the AP supports the first transmission mechanism. The STA is the first device, and the AP is the second device. Alternatively, the STA is the second device, and the AP is the first device.

At least one embodiment is applicable to vendor privatization customization, and the vendor determines, by using the first value state, that the PPDU carries the vendor specific information. In addition, at least one embodiment is also applied to a definition in a WLAN standard. In the WLAN standard that the first value state indicates some information. For example, in the WLAN standard that the first value state indicates modulation schemes of N spatial streams in an unequal modulation scheme, where modulation schemes of at least two spatial streams in the N spatial streams are different.

In at least one embodiment, one or more states of the any value state of the disregard bit, the non-default state of the validate bit, the disregard state, and the validate state are used as an identifier of unequal modulation information or the vendor specific information, so that the device supporting the first transmission mechanism reads the PPDU whose first field is in the first value state, and obtain the unequal modulation information or the vendor specific information from the PPDU. In the foregoing manner, PPDU information defined in an original standard does not conflict with PPDU information defined during vendor privatization customization or subsequent standard improvement.

For ease of understanding the solution, in at least one embodiment, an example in which the first value state indicates that the PPDU carries the vendor specific information is used for description. The following describes at least one embodiment by using an example in which the vendor specific information is modulation schemes of the N spatial streams in the unequal modulation scheme, where N is an integer greater than 1, and the modulation schemes of the at least two spatial streams are different.

Optionally, the data field of the PPDU includes the N spatial streams, and the at least two spatial streams have different modulation schemes.

In at least one embodiment, the first device uses a first value state to indicate that the PPDU carries the vendor specific information, and use at least one disregard bit in the PPDU to indicate a type of the vendor specific information. For example, in response to the vendor specific information being the unequal modulation scheme, the first device indicates, by using at least one disregard bit in the PPDU, that the vendor specific information is the unequal modulation scheme.

After the second device receives the PPDU, in response to the second device supporting the first transmission mechanism, the second device determines, based on the first value state, that the PPDU carries the vendor specific information, and determine, by reading the at least one disregard bit in the PPDU, that the vendor specific information is the unequal modulation scheme. The second device reads the PPDU to obtain the modulation schemes of the N spatial streams.

The following describes seven examples of the first value state. The following seven examples are merely examples for description, and are not used as a specific limitation on the first value state.

Example 1: The first field includes a PPDU type and compression mode subfield and a non-orthogonal frequency division multiple access (orthogonal frequency division multiple access, OFDMA) transmission user quantity subfield. The first value state is that the PPDU type and the compression mode subfield indicate single-user transmission, and the non-OFDMA transmission user quantity subfield indicates that a quantity of users participating in non-OFDMA transmission is greater than 1.

In Example 1, that the PPDU type and compression mode subfield indicates single-user transmission, and the non-OFDMA transmission user quantity subfield indicates that the quantity of the users participating in non-OFDMA transmission is greater than 1 is used as the validate state or the disregard state.

For equal modulation-based single-user transmission, in response to the PPDU type and compression mode subfield indicating single-user transmission, the non-OFDMA transmission user quantity subfield needs to indicate that the user quantity is 1, so that a receive end reads a unique user field, to obtain a modulation scheme in which a number of spatial streams and a number of all spatial streams are unified. In at least one embodiment, in response to the PPDU type and compression mode subfield indicating single-user transmission, the quantity of non-OFDMA users is indicated to be more than 1. That the PPDU type and compression mode subfield indicates single-user transmission, and the non-OFDMA transmission user quantity subfield indicates that the quantity of the users participating in non-OFDMA transmission is greater than 1 is used as the validate state or the disregard state. The PPDU type and the compression mode subfield indicates single-user transmission. A state in which the user quantity of non-OFDMA transmission is indicated to exceed 1 is considered as an identifier of the vendor specific information. A receive end that supports a transmission mechanism “The first value state indicates that the PPDU carries the vendor specific information” determines that the PPDU carries an identifier of the vendor specific information. A corresponding quantity of user fields appear subsequently based on indication of the user quantity of non-OFDMA. The vendor specific information is read from these user fields. A receive end that does not support the transmission mechanism “The first value state indicates that the PPDU carries the vendor specific information” uses, as the validate state or the disregard state, that the PPDU type and compression mode subfield indicates single-user transmission and a non-OFDMA transmission user quantity subfield indicates that the quantity of users participating in non-OFDMA transmission is greater than 1 for processing. For example, in response to the second device using the PPDU type and compression mode subfield to indicates single-user transmission, and the non-OFDMA user quantity is indicated to exceed 1 as the validate state, the second device waits until the PPDU ends, transfer information in a version independent field of the PPDU to a MAC layer, to ensure coexistence, and terminate receiving of the PPDU. Alternatively, in response to the second device that uses the PPDU type and compression mode subfield to indicates single-user transmission, and the non-OFDMA user quantity is indicated to be greater than 1 as the disregard state, the second device ignores a subfield in the disregard state, and continue to read another field. In this manner, vendor privatization customization is implemented without changing the PPDU information defined in a WLAN standard.

Based on Example 1, the PPDU indicates the modulation schemes of the N spatial streams by using a plurality of user fields. For example, the non-OFDMA transmission user quantity subfield indicates that a user quantity of is n, where n is an integer, and 1<n≤N. The PPDU includes n user fields, and the n user fields indicate the modulation schemes of the N spatial streams.

The n user fields indicates the modulation schemes of the N spatial streams in any one of the following six manners.

Manner 1: A 1^{st} user field in the n user fields indicates the quantity N of the spatial streams, an identifier of a target station, and a modulation scheme of a 1^{st} spatial stream, and 2^{nd} to n^{th} user fields indicate modulation schemes of 2^{nd} to N^{th} spatial streams.

For example, the 1^{st} user field uses a signaling format that is of a user field used for non-MU-MIMO user transmission and that is defined in a WLAN standard. For example, the first user field includes a station identifier subfield, a spatial stream indication subfield, and an MCS indication subfield. The station identifier subfield indicates an identifier of a target station. The spatial stream indication subfield indicates the number N of the spatial streams. The MCS indication subfield indicates the modulation scheme of the 1^{st} spatial stream.

The 2^{nd} to n^{th} user fields do not use the signaling format of the user field used for non-MU-MIMO user transmission and the signaling format of the user field used for MU-MIMO user transmission that are defined in the WLAN standard. The 2^{nd} to n^{th} user fields do not have a fixed signaling format, and the modulation schemes of the 2^{nd} to N^{th} spatial streams are indicated by combining bits of the second to the n^{th} user fields. In this manner, the 2^{nd} to n^{th} user fields is also combined into one field, and the field indicates the modulation schemes of the 2^{nd} to N^{th} spatial streams.

For example, one user field includes 22 bits, and a modulation scheme of a spatial stream needs to be indicated by four bits. In this case, in addition to a spatial stream (that is, the first spatial stream) indicated by the 1^{st} user field, a subsequent user field additionally carries modulation scheme information of five spatial streams, and two user fields additionally carry modulation scheme information of 11 spatial streams. Alternatively, the two user fields are combined into one field to carry the modulation scheme information of the 11 spatial streams, and the three user fields additionally carry modulation scheme information of 15 spatial streams. Similarly, the three user fields are combined into one field to carry the modulation scheme information of 15 spatial streams.

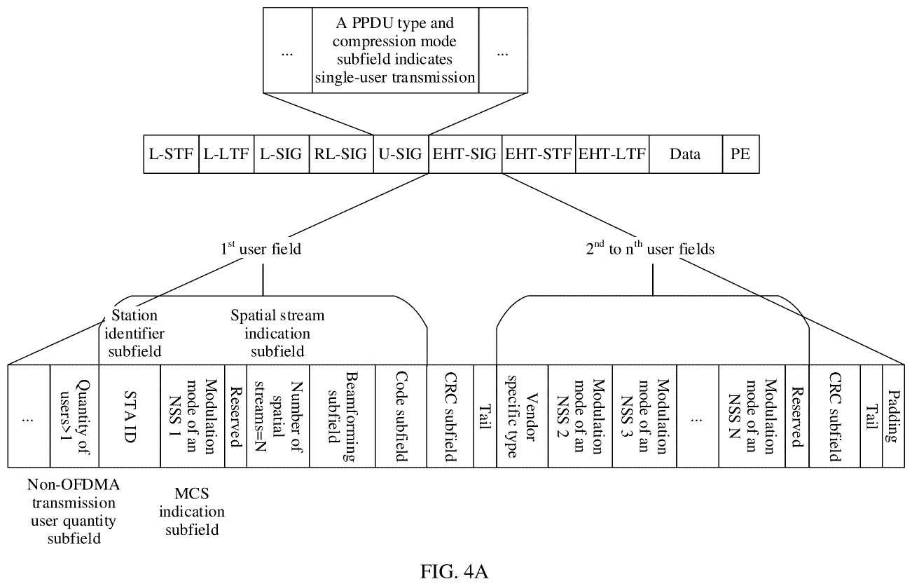

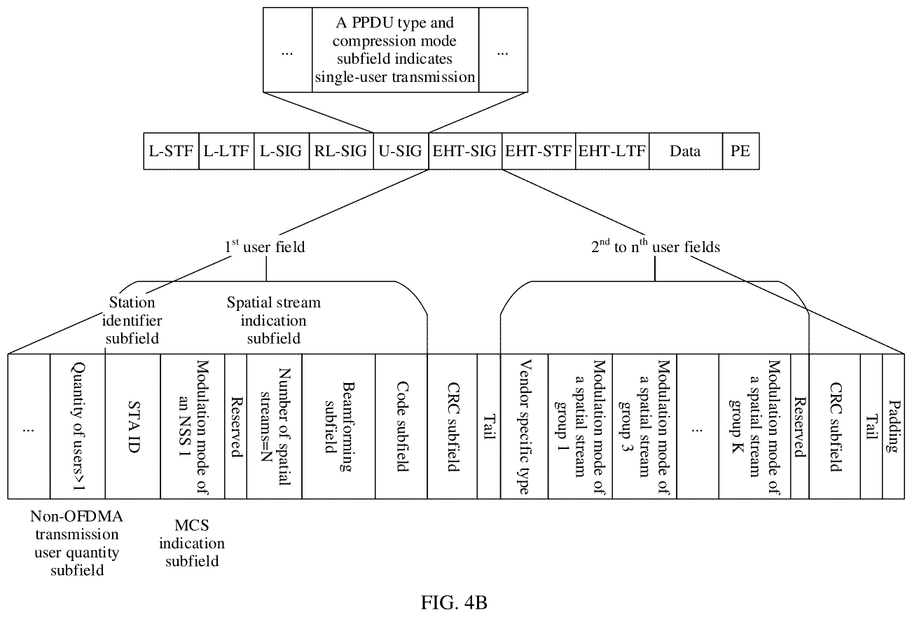

For example, the PPDU is shown in FIG. 4A.

Optionally, a manner of indicating the modulation scheme of the 1^{st} spatial stream is shown in Table 4.

TABLE 4

| Value | Indicated modulation scheme |
|---|---|
| 0 | BPSK, R = 1/2 |
| 1 | QSPK, R = 1/2 |
| 2 | QPSK, R = 3/4 |
| 3 | 16-QAM, R = 1/2 |
| 4 | 16-QAM, R = 3/4 |
| 5 | 64-QAM, R = 2/3 |
| 6 | 64-QAM, R = 3/4 |
| 7 | 64-QAM, R = 5/6 |
| 8 | 256-QAM, R = 3/4 |
| 9 | 256-QAM, R = 5/6 |
| 10 | 1024-QAM, R = 3/4 |
| 11 | 1024-QAM, R = 5/6 |
| 12 | 4096-QAM, R = 3/4 |
| 13 | 4096-QAM, R = 5/6 |
| 14 | BPSK, dual-carrier modulation, repetition, R = 1/2 |
| 15 | BPSK, dual-carrier modulation, R = 1/2 |

According to the indication manner shown in Table 4, the modulation scheme of the 1^{st} spatial stream needs to be indicated by at least four bits.

Optionally, modulation orders and/or bit rates of different spatial streams is different. Therefore, the modulation schemes of the 2^{nd} to N^{th} spatial streams need to indicate modulation orders and bit rates. A manner of indicating the modulation schemes of the 2^{nd} to N^{th} spatial streams is the same as a manner of indicating the modulation scheme of the first spatial stream. Therefore, a modulation scheme of one spatial stream in the 2^{nd} to N^{th} spatial streams needs to be indicated by at least four bits. For example, a user field includes 22 bits, and a modulation scheme of a spatial stream needs to be indicated by four bits. In addition to a spatial stream (that is, the 1^{st} spatial stream) indicated by the 1^{st} user field, a subsequent user field additionally carries modulation scheme information of five spatial streams, two user fields additionally carries modulation scheme information of 11 spatial streams, and three user fields additionally carries modulation scheme information of 15 spatial streams.

Alternatively, code rates of the 2^{nd} to N^{th} spatial streams are the same as a code rate of the first spatial stream. Therefore, the modulation schemes of the 2^{nd} to N^{th} spatial streams indicates modulation orders. A manner of indicating the modulation schemes of the 2^{nd} to N^{th} spatial streams are shown in Table 5.

TABLE 5

| Value | Indicated modulation scheme |
|---|---|
| 0 | BPSK |
| 1 | QPSK |
| 2 | 16-QAM |
| 3 | 64-QAM |
| 4 | 256-QAM |
| 5 | 1024-QAM |
| 6 | 4096-QAM |
| 7 | Reserved |

According to the indication manner shown in Table 5, a modulation scheme of any one of the 2^{nd} to N^{th} spatial streams needs at least three bits for indication. For example, a user field includes 22 bits, and a modulation scheme of a spatial stream needs to be indicated by three bits. In addition to a spatial stream (that is, 1^{st} first spatial stream) indicated by the 1^{st} user field, a subsequent user field additionally carries modulation scheme information of seven spatial streams, two user fields additionally carries modulation scheme information of 14 spatial streams, and three user fields additionally carries modulation scheme information of 22 spatial streams.

According to the indication manner shown in Table 5, the second device determines the modulation order and the bit rate of the 1^{st} spatial stream by reading the 1^{st} user field in the PPDU, and determine the modulation orders of the 2^{nd} to N^{th} spatial streams by reading the 2^{nd} to n^{th} user fields in the PPDU. Because the bit rates of the 2^{nd} to N^{th} spatial streams is the same as the bit rate of the 1^{st} spatial stream, therefore, the second device determines the bit rates of the 2^{nd} to N^{th} spatial streams based on the bit rate of the 1^{st} spatial stream.

In Manner 1, the first device flexibly adjusts, based on the quantity of the spatial streams and in the foregoing manner, the user quantity indicated by the non-OFDMA transmission user quantity subfield, to flexibly adjust a quantity of user fields, thereby reducing signaling overheads. For example, a user field includes 22 bits, and a modulation scheme of a spatial stream needs to be indicated by four bits. In response to there being three spatial streams, that is, N=3, and the non-OFDMA transmission user quantity subfield indicates that the user quantity is 2, the PPDU includes two user fields. A 1^{st} user field indicates a modulation scheme of a 1^{st} spatial stream, and a 2^{nd} user field indicates modulation schemes of a 2^{nd} spatial stream and a 3^{rd} spatial stream. In response to there being nine spatial streams, that is, N=9, and the non-OFDMA transmission user quantity subfield indicates that the quantity of users is 3, the PPDU includes three user fields. A 1^{st} user field indicates a modulation scheme of a 1^{st} spatial stream, and a 2^{nd} user field indicates modulation schemes of 2^{nd} to 9^{th} spatial streams.

Optionally, the first device alternatively determines, based on a maximum quantity of spatial streams that are implemented, the user quantity indicated by the non-OFDMA transmission user quantity subfield, to determine the quantity of user fields. For example, one user field includes 22 bits, and a modulation scheme of one spatial stream needs to be indicated by 3 bits. If the maximum quantity of the spatial streams that is implemented by the first device is 16, the non-OFDMA transmission user quantity subfield indicates four users. In this case, the PPDU includes four user fields, the 1^{st} user field indicates the modulation scheme of the first spatial stream, and the 2^{nd} user field to 4^{th} user field indicates modulation schemes of remaining spatial streams. In this manner, a length of the PPDU is fixed, and processing at the receive end is easy to implement.

Alternatively, the PPDU includes a fixed quantity of user fields. In response to the number of the spatial streams exceeding a number of spatial streams that are indicated by the fixed quantity of user fields, one or more spatial streams are combined into one spatial stream group. For example, the PPDU includes three user fields. For example, one user field includes 22 bits, and a modulation scheme of one spatial stream needs to be indicated by three bits. The 1^{st} user field indicates one spatial stream, and the 2^{nd} and the 3^{rd} user fields indicates 14 spatial streams in total. Therefore, the three user fields indicates 15 spatial streams in total. In response to the total number N of the spatial streams≤15, 44 bits in the 2^{nd} user field and the 3^{rd} user field respectively indicates modulation schemes of the second to the N^{th} spatial streams. In response to N=16, assuming that a modulation scheme of a 16^{th} spatial stream is the same as a modulation scheme of a 15^{th} spatial stream, the 15^{th} spatial stream and the 16^{th} spatial stream is combined into one group. Alternatively, any two spatial streams are combined into one group by using another combination method.

In addition to the bit used to indicate the modulation scheme of the spatial stream, there are remaining bits in the user field of the PPDU. In an implementation, the remaining bits are used to indicate the type of the vendor specific information. The remaining two bits are used as an example. 00 indicates that the vendor specific information is a modulation scheme for unequal modulation of each spatial stream, 01 indicates that the vendor specific information is HARQ-related indication, 10 indicates that the vendor specific information is AP coordination-related indication, and 11 is reserved. In response to the vendor specific information being a modulation scheme of unequal modulation of each spatial stream, the value of the remaining two bits are 00. In response to the vendor specific information being the HARQ-related indication, the value of the remaining two bits are 01. In response to the vendor specific information being the AP coordination-related indication, the value of the remaining two bits are 10. In at least one embodiment, an example in which the vendor specific information is the modulation scheme for unequal modulation of each spatial stream is used for description. Therefore, the value of the remaining two bits are 00, to indicate that the vendor specific information is the modulation scheme for unequal modulation of each spatial stream.

In response to at least one embodiment being applied to a definition in a WLAN standard, the remaining bits and the non-OFDMA transmission user quantity subfield indicates a plurality of functions. For example, the remaining two bits are used as an example. In response to the non-OFDMA transmission user quantity subfield indicating that the user quantity is greater than 1, the remaining bits uses 00 to indicate that the vendor specific information is a modulation scheme for unequal modulation of each spatial stream, 01 indicates that the vendor specific information is the HARQ-related indication, 10 indicates that the vendor specific information is the AP coordination-related indication, and 11 is reserved.

Manner 2: The 1^{st} user field in the n user fields indicates the quantity of spatial streams, the identifier of the target station, and the modulation scheme of the 1^{st} spatial stream. The 2^{nd} to N^{th} spatial streams are divided into K spatial stream groups. 2^{nd} to n^{th} user fields indicate modulation schemes of the K spatial stream groups, where K is an integer, and 0<K≤N−1.

For example, the PPDU is shown in FIG. 4B.

In an implementation, a grouping manner of the K spatial stream groups are fixed. A grouping manner corresponding to each value of the total number of spatial streams (number of spatial streams, NSS) is fixed, that is, a quantity of spatial stream groups and a number of spatial streams in each group that correspond to each value of the NSS are fixed. For example, in response to NSS=2, the grouping manner is: grouping into two groups, where each spatial stream group includes one spatial stream. In response to NSS=3, the grouping manner is: grouping into three groups, where each spatial stream group includes one spatial stream. In response to NSS=4, the grouping manner is: grouping into four groups, where each spatial stream group includes one spatial stream. In response to NSS=5, the grouping manner is: grouping into four groups, and numbers of spatial streams included in the four spatial stream groups are respectively 2, 1, 1, and 1. In response to NSS=6, the grouping manner is: grouping into four groups, and numbers of spatial streams included in the four spatial stream groups are respectively 2, 2, 1, and 1. In response to NSS=7, the grouping manner is: grouping into four groups, and numbers of spatial streams included in the four spatial stream groups are respectively 2, 2, 2, and 1. In response to NSS=8, the grouping manner is: grouping into four groups, and numbers of spatial streams included in the four spatial stream groups are respectively 2, 2, 2, and 2. In response to NSS=9, the grouping manner is: grouping into four groups, and numbers of spatial streams included in the four spatial stream groups are respectively 3, 2, 2, and 2. In response to NSS=10, the grouping manner is: grouping into four groups, and numbers of spatial streams included in the four spatial stream groups are respectively 3, 3, 2, and 2. In response to NSS=11, the grouping manner is: grouping into four groups, and numbers of spatial streams included in the four spatial stream groups are respectively 3, 3, 3, and 2. In response to NSS=12, the grouping manner is: grouping into four groups, and numbers of spatial streams included in the four spatial stream groups are respectively 3, 3, 3, and 3. For example, 1^{st} to 3^{rd} spatial streams are in one group, and 4^{th} to 6^{th} spatial streams are in one group. In response to NSS=13, the grouping manner is: grouping into four groups, and numbers of spatial streams included in the four spatial stream groups are respectively 4, 3, 3, and 3. In response to NSS=14, the grouping manner is: grouping into four groups, and numbers of spatial streams included in the four spatial stream groups are respectively 4, 4, 3, and 3. In response to NSS=15, the grouping manner is: grouping into four groups, and numbers of spatial streams included in the four spatial stream groups are respectively 4, 4, 4, and 3. In response to NSS=16, the grouping manner is: grouping into four groups, and numbers of spatial streams included in the four spatial stream groups are respectively 4, 4, 4, and 4.

The foregoing grouping manner is merely an example for description. A specific quantity of groups into which spatial streams are grouped and a number of spatial streams in each group are not specifically limited herein.

In response to each spatial stream group including one spatial stream, a quantity of spatial stream groups obtained through grouping is equal to a total number of spatial streams, that is, K=N−1. In this case, in Manner 2, the 2^{nd} to N^{th} spatial streams are indicated by using the second to the n^{th} user fields, and an implementation of Manner 2 is the same as that of Manner 1.

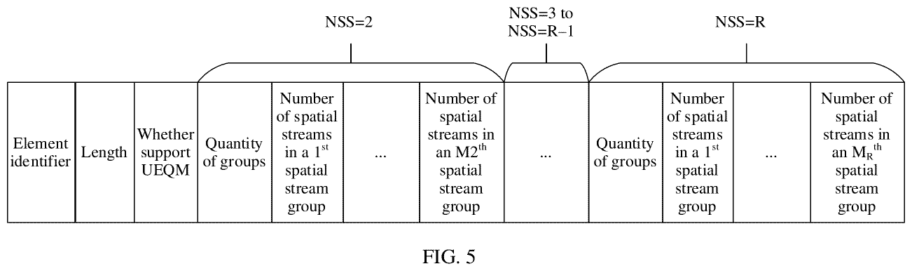

In another implementation, the grouping manner of the K spatial stream groups alternatively are determined by the first device and the second device through negotiation in advance. The first device and the second device negotiate, in advance, grouping information corresponding to different total numbers of spatial streams. The grouping information includes at least one of the following information: the total number K of the spatial stream groups, and a number of spatial streams in each of the K spatial stream groups. For example, the first device and the second device negotiate the grouping manner by using negotiation information of a signaling format shown in FIG. 5. The negotiation information includes an element identifier field used to indicate an element identifier, a length field used to indicate a length, a UEQM field used to indicate whether unequal (unequal) modulation (unequal modulation, UEQM) is supported, and further includes grouping information corresponding to a total number of spatial streams. In response to NSS=1, the grouping information includes a number of spatial streams of each of M₁ spatial stream groups. In response to NSS=1, only one spatial stream group is included, the spatial stream group includes one spatial stream, and the negotiation information does not include grouping information in response to NSS=1. In response to NSS=2, the grouping information includes a number of spatial streams of each of M₂ spatial stream groups. Optionally, the negotiation information does not include grouping information in response to NSS=2. By analogy, in response to NSS=R, the grouping information includes a number of spatial streams in each of M_{R} spatial stream groups. R is a maximum number of spatial streams supported by the first device. Optionally, the negotiation information is carried in an information element of a management frame, where the information element is a unit that carries information in the management frame.

Optionally, the first device and the second device negotiate a manner of grouping spatial streams in an association process. For example, the AP adds corresponding negotiation information to a beacon frame to be sent, and the STA adds the corresponding negotiation information to an association request frame or a reassociation request frame. The AP is the first device, and the STA is the second device, or the AP is the second device, and the STA is the first device. Alternatively, the first device and the second device negotiate the grouping information of the spatial stream by using a management frame in a data exchange process.

When the first device and the second device negotiate the grouping manner of the spatial streams, the first device determines the grouping manner of the spatial streams and notify the second device of the grouping manner. Alternatively, the first device sends a request message to the second device, where the request message is used to request to negotiate grouping information of the spatial stream. The second device feeds back, to the first device, whether to accept the request message. In response to the second device not receiving the request message, the second device sends indication information to the first device, where the indication information indicates grouping information expected by the second device.

Manner 3: The N spatial streams are divided into H spatial stream groups. In response to N=1, H is equal to a quantity M₁ of spatial stream groups corresponding to one spatial stream. In response to N=2, H is equal to a quantity M₂ of spatial stream groups corresponding to two spatial streams. In response to N=3, H is equal to a quantity M₃ of spatial stream groups corresponding to three spatial streams, and so on. In response to N=R, H is equal to a group quantity M_{R} of spatial stream groups corresponding to R spatial streams. R is a maximum number of spatial streams supported by the first device. One of the n user fields indicates a modulation scheme of one spatial stream group, and modulation schemes of spatial streams included in all spatial stream groups are the same.

In Manner 3, the user quantity n indicated by the non-OFDMA transmission user quantity subfield is equal to the quantity H of the spatial stream groups into which the N spatial streams are divided. In other words, the user quantity indicated by the non-OFDMA transmission user quantity subfield is H, and the PPDU indicates the modulation schemes of the H spatial stream groups by using the H user fields.

In an implementation, the H user fields uses a signaling format that is of a user field used for MU-MIMO user transmission and that is defined in a WLAN standard. For example, the user field includes a station identifier subfield, a spatial stream allocation subfield, and an MCS indication subfield. The station identifier subfield indicates an identifier of a target station, the spatial stream allocation subfield indicates a number of spatial streams in each of the H spatial stream groups, and the MCS indication subfield indicates a modulation scheme of a spatial stream group.

A station identifier subfield in an i^{th} user field indicates an identifier of a target station, the spatial stream allocation subfield indicates a number of spatial streams in each of the H spatial stream groups, the MCS indication subfield indicates a modulation scheme of an i^{th} spatial stream group, and i is an integer greater than 0 and not greater than H.

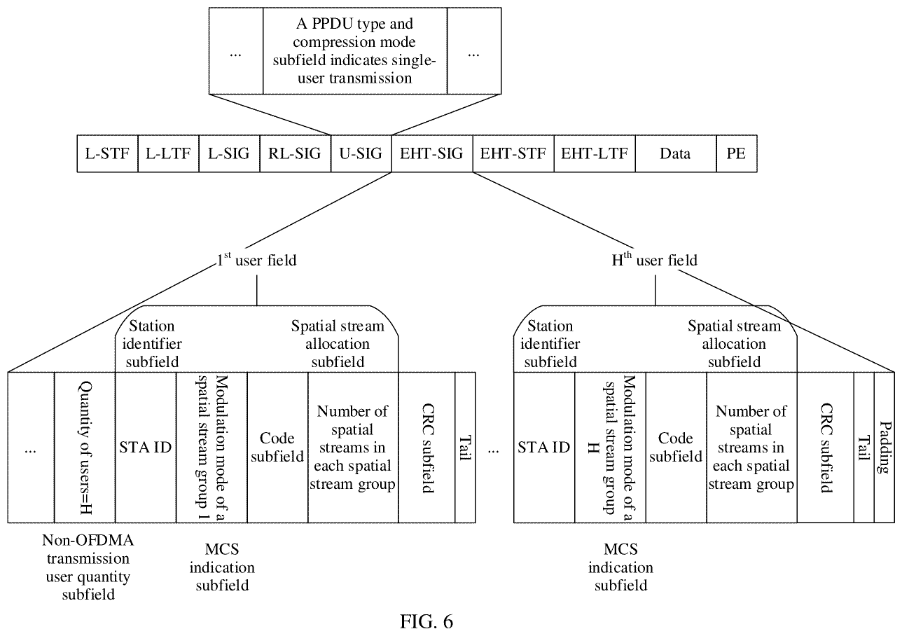

For example, the PPDU is shown in FIG. 6.

In another implementation, the H user fields uses a signaling format that is of a user field used for non-MU-MIMO user transmission and that is defined in a WLAN standard. For example, the user field includes a station identifier subfield, a spatial stream indication subfield, and an MCS indication subfield. The station identifier subfield indicates an identifier of a target station, the spatial stream indication subfield indicates a number of spatial streams of spatial stream groups, and the MCS indication subfield indicates a modulation scheme of a spatial stream group.

A station identifier subfield in an i^{th} user field indicates an identifier of a target station, the spatial stream allocation subfield indicates a number of spatial streams in each of an i^{th} spatial stream group, the MCS indication subfield indicates a modulation scheme of the i^{th} spatial stream group, and i is an integer greater than 0 and not greater than H.

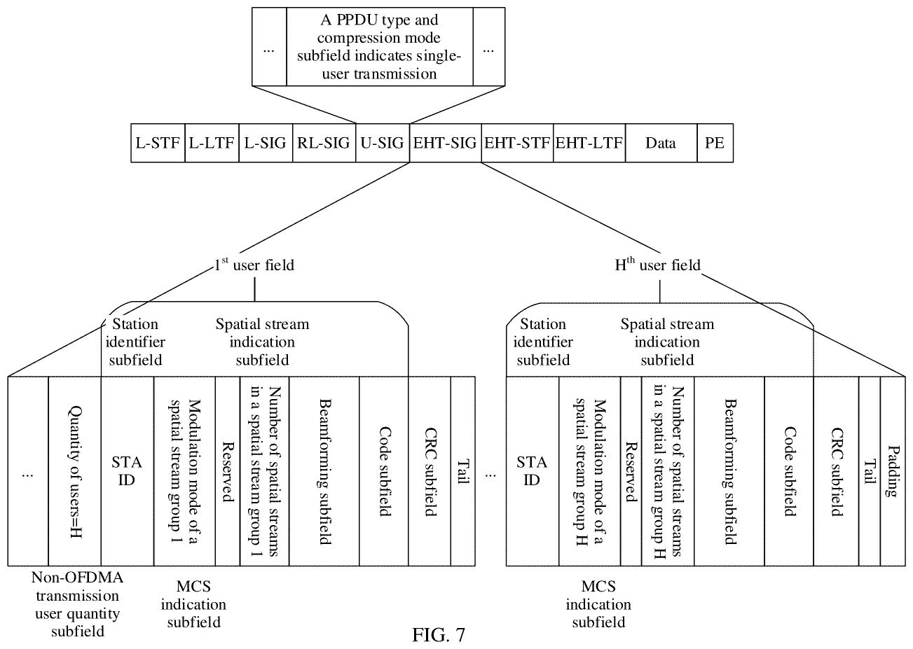

For example, the PPDU is shown in FIG. 7.

Optionally, for an indication manner of the modulation schemes of the H spatial stream groups, refer to related descriptions in Manner 1. Details are not described herein again.

In Manner 3, one user field indicates a modulation scheme of one spatial stream group. Therefore, the total quantity H of the spatial stream groups are indicated by using the user quantity indicated by the non-OFDMA transmission user quantity subfield.

Manner 4: The N spatial streams are divided into H spatial stream groups. A first user field in n user fields indicates grouping information of spatial streams, for example, a total quantity H of spatial stream groups and a number of spatial streams in each of the H spatial stream groups. n−1 user fields other than the first user field in the n user fields indicates modulation information of the H spatial stream groups. The first user field is any one of the n user fields.

In an implementation, the first user field is a user field including a station identifier subfield that is of a specific value. The user field including the station identifier subfield that is of the specific value indicates grouping information of spatial streams, for example, the total quantity H of the spatial stream groups and the number of the spatial streams in each of the H spatial stream groups. For ease of description, the user field including the station identifier subfield that is of the specific value is referred to as a special user field below. n−1 user fields other than the special user field in the n user fields specifically indicate the modulation schemes of the H spatial stream groups.

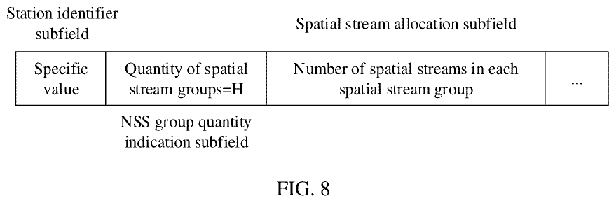

For example, the special user field includes an NSS group quantity indication subfield and a spatial stream allocation subfield. The NSS group quantity indication subfield indicates a total quantity H of spatial stream groups. The spatial stream allocation subfield indicates the number of the spatial streams in each of the H spatial stream groups. The special user field is shown in FIG. 8.

Optionally, a spatial stream allocation subfield in the special user field is similar to a spatial stream allocation subfield in the 802.11be standard. The spatial stream allocation subfield in the 802.11be standard indicates a spatial stream allocation indication between users in MU-MIMO transmission. In the 802.11be standard, the spatial stream allocation subfield traverses the number of the spatial streams of each user in an index manner based on a quantity of non-OFDMA transmission users.

The spatial stream allocation subfield in the special user field traverses the number of the spatial streams in each spatial stream group in the index manner based on the quantity of the spatial stream groups. For example, the quantity H of the spatial stream groups is 2 or 3, as shown in Table 6.

TABLE 6

| | | Number of | Number of | Number of | Number of | Number of | Number of | Number of | Number of | Total |
|---|---|---|---|---|---|---|---|---|---|---|
| Quantity of | 6 | spatial | spatial | spatial | spatial | spatial | spatial | spatial | spatial | number of |
| spatial | bits | streams in | streams in | streams in | streams in | streams in | streams in | streams in | streams in | spatial |
| streams | indication | group 1 | group 2 | group 3 | group 4 | group 5 | group 6 | group 7 | group 8 | streams |
| 2 | 000000- | 1-4 | 1 | | | | | | | 2-5 |
| | 000011 | | | | | | | | | |
| | 000100- | 2-4 | 2 | | | | | | | 4-6 |
| | 000110 | | | | | | | | | |
| | 000111- | 3-4 | 3 | | | | | | | 6-7 |
| | 001000 | | | | | | | | | |
| | 001001 | 4 | 4 | | | | | | | 8 |
| 3 | 000000- | 1-4 | 1 | 1 | | | | | | 3-6 |
| | 000011 | | | | | | | | | |
| | 000100- | 2-4 | 2 | 1 | | | | | | 5-7 |
| | 000110 | | | | | | | | | |
| | 000111- | 3-4 | 3 | 1 | | | | | | 7-8 |
| | 001000 | | | | | | | | | |
| | 001001 | 4 | 4 | 1 | | | | | | 9 |
| | 001010- | 2-4 | 2 | 2 | | | | | | 6-8 |
| | 001100 | | | | | | | | | |
| | 001101- | 3-4 | 3 | 2 | | | | | | 8-9 |
| | 001110 | | | | | | | | | |
| | 001111 | 4 | 4 | 2 | | | | | | 10 |
| | 010000- | 3-4 | 3 | 3 | | | | | | 9-10 |
| | 010001 | | | | | | | | | |
| | 010010 | 4 | 4 | 3 | | | | | | 11 |
| | 010011 | 4 | 4 | 4 | | | | | | 12 |

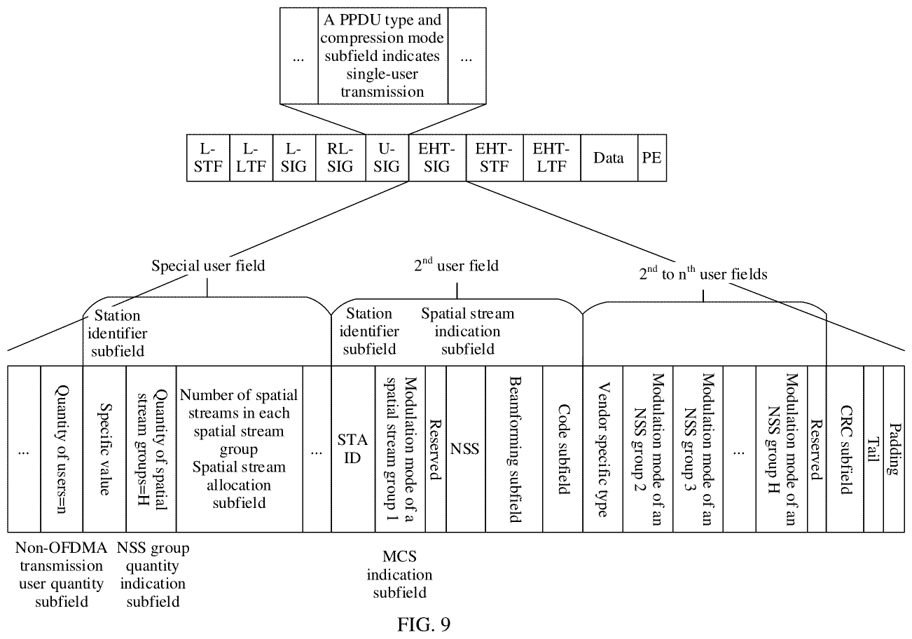

Optionally, that the n−1 user fields indicate the modulation schemes of the H spatial stream groups are similar to a manner in which the 2^{nd} to n^{th} user fields indicate the 2^{nd} to N^{th} spatial streams in Manner 1. A difference lies in that in Manner 1, one spatial stream is used as a unit for indication, and in Manner 3, one spatial stream group is used as a unit for indication. For details that the n−1 user fields indicate the modulation schemes of the H spatial stream groups, refer to related descriptions in Manner 1. Details are not described herein again. For example, the PPDU is shown in FIG. 9.

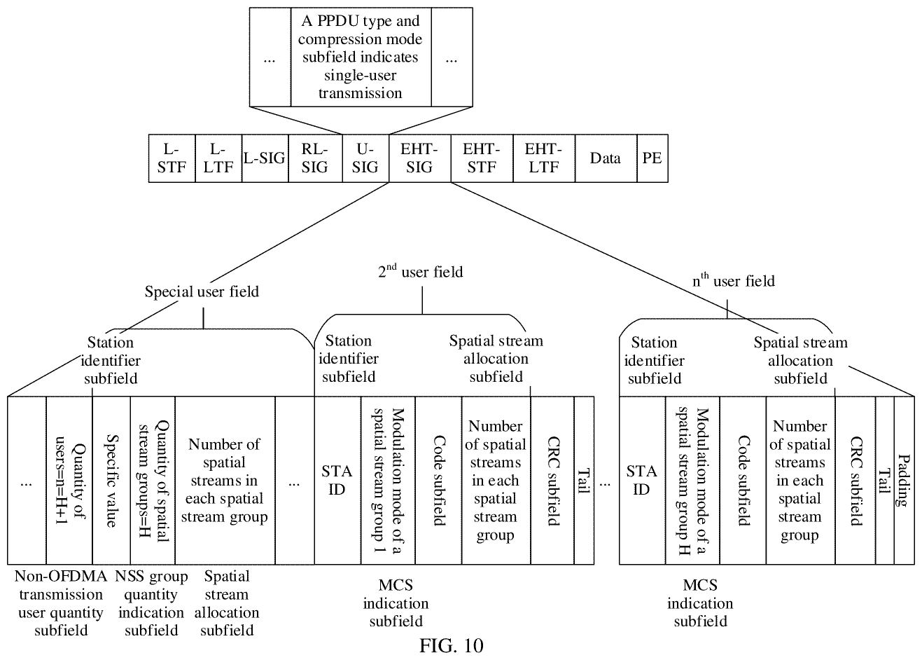

Alternatively, the modulation scheme in which the n−1 user fields indicate the H spatial stream groups are similar to a manner in which the 2nd to n^{th} user fields indicate the K spatial stream groups in Manner 2. For details, refer to related descriptions in Manner 2. Details are not described herein again. For example, the PPDU is shown in FIG. 10.

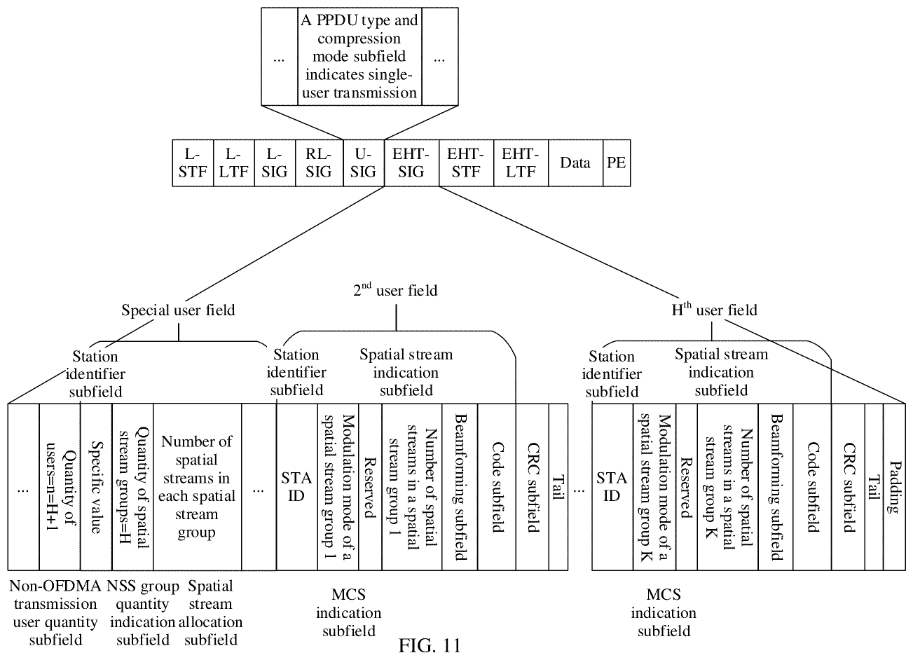

Alternatively, the modulation scheme in which the n−1 user fields indicate the H spatial stream groups are similar to the manner in which the H user fields indicate the H spatial stream groups in Manner 3. For details, refer to related descriptions in the foregoing manner 3. Details are not described herein again. For example, the PPDU is shown in FIG. 11.

Manner 5: The N spatial streams are divided into H spatial stream groups. A 1^{th} user field in the n user fields indicates a total quantity H of spatial stream groups, an identifier of a target station, and a modulation scheme of a 1^{st} spatial stream group. 2^{nd} to n^{th} user fields indicate modulation schemes of 2^{nd} to H^{th} spatial stream groups.

Optionally, that the n user fields indicate the modulation schemes of the H spatial stream groups are similar to a manner in which the n user fields indicate the N spatial streams in Manner 1. A difference lies in that in Manner 1, one spatial stream is used as a unit for indication, and in Manner 5, one spatial stream group is used as a unit for indication. For details that the n user fields indicate the modulation schemes of the H spatial stream groups, refer to related descriptions in Manner 1. Details are not described herein again.

Manner 6: One user field in the n user fields indicates a modulation scheme of one spatial stream. In this manner, the quantity n of user fields are equal to the quantity N of spatial streams. The PPDU includes N user fields. A j^{th} user field in the N user fields indicates a modulation scheme of a j^{th} spatial stream of the N spatial streams, j is an integer, and 1≤j≤N.

Optionally, that the n user fields indicate the modulation schemes of the N spatial streams is similar to a manner in which the n user fields indicate the H spatial stream groups in Manner 3. A difference lies in that in Manner 3, one spatial stream group is used as a unit for indication, and in Manner 6, one spatial stream is used as a unit for indication. For details that the modulation schemes of the N spatial streams indicated by the n user fields, refer to related descriptions in Manner 3. Details are not described herein again.

Example 2: The first field also includes a PPDU type and compression mode subfield, a non-OFDMA transmission user quantity subfield, and a user field. The first value state is that the PPDU type and the compression mode subfield indicate single-user transmission. The non-OFDMA transmission user quantity subfield indicates that the quantity of users participating in non-OFDMA transmission is greater than 1, and there is a user field whose station identifier subfield is of a specific value (that is, there is a special user field).

In Example 2, that the PPDU type and compression mode subfield indicates single-user transmission, the non-OFDMA transmission user quantity subfield indicates that the quantity of the users participating in non-OFDMA transmission is greater than 1, and there is a user field whose station identifier subfield is of a specific value is used as the validate state or the disregard state.

Example 3: The first field alternatively includes a non-OFDMA transmission user quantity subfield and a user field. The first value state is that the non-OFDMA transmission user quantity subfield indicates that a quantity of users participating in non-OFDMA transmission is greater than 1, and there is a user field whose station identifier subfield is of a specific value (that is, there is a special user field).

In Example 3, that the non-OFDMA transmission user quantity subfield indicates that the quantity of the users participating in non-OFDMA transmission is greater than 1, and there is a user field whose station identifier subfield is of a specific value is used as the validate state or the disregard state.

Example 4: The first field also includes a PPDU type and compression mode subfield and a user field. The first value state is that the PPDU type and the compression mode subfield indicate single-user transmission, and there is a user field whose station identifier subfield is of a specific value (that is, there is a special user field).

In Example 4, that the PPDU type and compression mode subfield indicates single-user transmission, and there is a user field whose station identifier subfield is of a specific value is used as the validate state or the disregard state.

Example 5: Alternatively, the first field includes only a user field. The first value state is that there is a user field whose station identifier subfield is of a specific value (that is, there is a special user field).

In Example 5, that there is a user field whose station identifier subfield is of a specific value is used as the validate state or the disregard state.

Optionally, in Example 3 to Example 5, for a manner of indicating the modulation schemes of the N spatial streams, refer to a manner in which the special user field indicates the total quantity H of the spatial stream groups and the number of spatial streams in each of the H spatial stream groups in Manner 4. n−1 user fields in the n user fields except the special user field specifically indicate the modulation schemes of the H spatial stream groups. Details are not described herein again.

Example 6: The first value state is also a validate state defined in a WLAN standard. For example, the first value state is one or more validate states defined in the 802.11be standard.

For example, the first value state is that the value of an uplink/downlink subfield is 0 (or the uplink/downlink subfield indicates downlink), and the value of the PPDU type and compression mode subfield is 3. Alternatively, the first value state is also that the value of the uplink/downlink subfield is 1 (or the uplink/downlink subfield indicates uplink), and the value of the PPDU type and compression mode subfield is 3.

For example, the first value state is shown in Table 7.

TABLE 7

| | | Description | | | | |
|---|---|---|---|---|---|---|
| | | | | Whether a | | |
| | | | | resource | | |
| U-SIG field | | | | unit | | |
| | EHT PPDU | | | allocation | Quantity | |
| | type and | | Whether | indication | of users | |
| | compression | EHT | EHT-SIG | subfield | in a | |
| Uplink/Downlink | mode | PPDU type | exists? | exists? | PPDU | Note |
| 0 (downlink) | 0 | EHT MU | Yes | Yes | ≥1 | DL OFDMA, |
| | | | | | | including non- |
| | | | | | | MU-MIMO |
| | | | | | | and MU- |
| | | | | | | MIMO |
| | 1 | EHT MU | Yes | No | 1 | SU or NDP |
| | | | | | | (not sent to an |
| | | | | | | AP, usually |
| | | | | | | refers to |
| | | | | | | downlink) |
| | 2 | EHT MU | Yes | No | >1 | DL MU- |
| | | | | | | MIMO (non- |
| | | | | | | OFDMA |
| | | | | | | transmission) |
| | 3 | — | — | — | — | First value |
| | | | | | | state |
| 1 (uplink) | 0 | EHT TB | No | — | ≥1 | UL OFDMA |
| | | (based on | | | | (including |
| | | triggering) | | | | non-MU- |
| | | | | | | MIMO and |
| | | | | | | MU-MIMO) |
| | 1 | EHT MU | Yes | No | 1 | SU or NDP |
| | | | | | | (sent to an AP, |
| | | | | | | that is, uplink) |
| | 2 | — | — | — | — | Validate |
| | 3 | | | | | First value |
| | | | | | | state |

Example 7: the first value state is also indicated by using a validate state defined in a WLAN standard and a validate bit defined in the WLAN standard. For example, the first value state is indicated by using a validate state and a validate bit defined in the 802.11be standard.

For example, the first value state is that the value of the uplink/downlink subfield is 0 (or the uplink/downlink subfield indicates downlink), the value of the PPDU type and compression mode subfield is 3, and one validate bit of the U-SIG field is 0. Alternatively, the first value state is also that the value of the uplink/downlink subfield is 1 (or the uplink/downlink subfield indicates uplink), the value of the PPDU type and compression mode subfield is 3, and one validate bit of the U-SIG field is 0.

For example, the first value state is shown in Table 8.

TABLE 8

| | | | Description | | | | |
|---|---|---|---|---|---|---|---|
| | | | | | Whether | | |
| | | | | | a resource | | |
| U-SIG field | | | | | unit | | |
| | PPDU type | Validate | | | allocation | Quantity | |
| | and | bit | EHT | Whether | indication | of users | |
| | compression | (extended | PPDU | EHT-SIG | subfield | in a | |
| Uplink/Downlink | mode | bit) | type | exists? | exists? | PPDU | Note |
| 0 (downlink) | 0 | 1 (default | EHT MU | Yes | Yes | ≥1 | DL OFDMA, |
| | | value) | | | | | including |
| | | | | | | | non-MU- |
| | | | | | | | MIMO and |
| | | | | | | | MU-MIMO |
| | 1 | 1 (default | EHT MU | Yes | No | 1 | SU or NDP |
| | | value) | | | | | (not sent to |
| | | | | | | | an AP, |
| | | | | | | | usually refers |
| | | | | | | | to downlink) |
| | 2 | 1 (default | EHT MU | Yes | No | >1 | DL MU- |
| | | value) | | | | | MIMO (non- |
| | | | | | | | OFDMA |
| | | | | | | | transmission) |
| | 3 | 1 (default | — | — | — | — | Validate |
| | | value) | | | | | |
| | 0-2 | 0 (non- | — | — | — | — | Validate |
| | | default | | | | | |
| | | value) | | | | | |
| | 3 | 0 (non- | — | — | — | — | First value |
| | | default | | | | | state |
| | | value) | | | | | |
| 1 (uplink) | 0 | 1 (default | EHT TB | No | — | ≥1 | UL OFDMA |
| | | value) | (trigger | | | | (including |
| | | | based, | | | | non-MU- |
| | | | based on | | | | MIMO and |
| | | | triggering) | | | | MU-MIMO) |
| | 1 | 1 (default | EHT MU | Yes | No | 1 | SU or NDP |
| | | value) | | | | | (sent to an |
| | | | | | | | AP, that is, |
| | | | | | | | uplink) |
| | 2 | 1 (default | — | — | — | — | Validate |
| | | value) | | | | | |
| | 0-2 | 0 (non- | | | | | Validate |
| | | default | | | | | |
| | | value) | | | | | |
| | 3 | 0 (non- | | | | | First value |
| | | default | | | | | state |
| | | value) | | | | | |

Optionally, in Example 6 and Example 7, for a manner of indicating the modulation schemes of the N spatial streams, refer to the manner of indicating the modulation schemes of the N spatial streams in Example 1. Details are not described herein again.

In at least one embodiment, after receiving the PPDU, the second device checks and codes the 1^{st} user field in the PPDU together with a common part, and a subsequent user field is checked and coded by using two user fields as a group. In response to the last group including one user field, the user field is checked and coded independently.

In at least one embodiment, one or more of the disregard state, the validate state, any state of the disregard bit, and the non-default state of the validate bit are defined as the identifier of the vendor specific information, so that the device supporting the first transmission mechanism reads the corresponding vendor specific information based on the first value state. For a device that does not support the first transmission mechanism, the state is considered as the disregard state or the validate state, so that interworking between devices is not affected.

Any one of the validate state, the disregard state, the non-default state of the validate bit, and the disregard bit other than the first value state is not used by each vendor, and therefore is used for subsequent standard extension to support more extended features. In addition, the validate state does not conflict with a vendor specific feature, and does not cause an interoperability problem.

In addition, the WLAN standard starts from 802.11a/b/g and goes through 802.11n, 802.11ac, to 802.11ax. 802.1a/b/g supports only a single spatial stream and does not support MIMO. 802.11n supports MIMO of a maximum of four spatial streams. Each spatial stream uses a different MCS to adapt to a signal-to-noise ratio (signal-to-noise ratio, SNR) of a different spatial stream. This mode is called UEQM. Based on a number of spatial streams, each case is traversed in an index manner. For example, the MCS field includes 7 bits, and 20 MHz or 40 MHz is indicated based on the CBW. The MCS field is shown in Table 9.

TABLE 9

| MCS field | |
|---|---|
| indication | Meaning |
| 0 | BPSK, R = 1/2, 1 spatial stream (spatial stream, SS) |
| 1 | QPSK, R = 1/2, 1SS |
| 2 | QPSK, R = 3/4, 1SS |
| 3 | 16-QAM, R = 1/2, 1SS |
| 4 | 16-QAM, R = 3/4, 1SS |
| 5 | 64-QAM, R = 2/3, 1SS |
| 6 | 64-QAM, R = 3/4, 1SS |
| 7 | 64-QAM, R = 5/6, 1SS |
| 8-15 | Modulation corresponds to MCS 0-7, 2SS, equal modulation |
| 16-23 | Modulation corresponds to MCS 0-7, 3SS, equal modulation |
| 24-31 | Modulation corresponds to MCS 0-7, 4SS, equal modulation |
| 32 | In response to a bandwidth being 20 MHz, reserved |
| | In response to a bandwidth being 40 MHz, indicate a |
| | replicated 20 MHz mode |
| 33-38 | 2SS, unequal modulation |
| 39-52 | 3SS, unequal modulation |
| 53-76 | 4SS, unequal modulation |

In an implementation, the MCS indicates both a modulation and coding scheme and a number of spatial streams. In the unequal modulation scheme, using 20 MHz and two spatial streams as an example, a manner in which the MCS indicates the modulation and coding scheme and the number of the spatial streams are shown in Table 10.

TABLE 10

| MCS field | Modulation | | |
|---|---|---|---|
| indication | Spatial stream 1 | Spatial stream 2 | R |
| 33 | 16-QAM | QPSK | 1/2 |
| 34 | 64-QAM | QPSK | 1/2 |
| 35 | 64-QAM | 16-QAM | 1/2 |
| 36 | 16-QAM | QPSK | 3/4 |
| 37 | 64-QAM | QPSK | 3/4 |
| 38 | 64-QAM | 16-QAM | 3/4 |

In the unequal modulation scheme, using 20 MHz and two spatial streams as an example, a manner in which the MCS indicates the modulation and coding scheme and the number of the spatial streams are shown in Table 11.

TABLE 11

| MCS field | Modulation | | | |
|---|---|---|---|---|
| indication | Spatial stream 1 | Spatial stream 2 | Spatial stream 3 | R |
| 39 | 16-QAM | QPSK | QPSK | 1/2 |
| 40 | 64-QAM | 16-QAM | QPSK | 1/2 |
| 41 | 64-QAM | QPSK | QPSK | 1/2 |
| 42 | 16-QAM | 16-QAM | QPSK | 1/2 |
| 43 | 64-QAM | 16-QAM | 16-QAM | 1/2 |
| 44 | 64-QAM | 64-QAM | QPSK | 1/2 |
| 45 | 64-QAM | 64-QAM | 16-QAM | 1/2 |
| 46 | 16-QAM | QPSK | QPSK | 3/4 |
| 47 | 16-QAM | 16-QAM | QPSK | 3/4 |
| 48 | 64-QAM | QPSK | QPSK | 3/4 |
| 49 | 64-QAM | 64-QAM | QPSK | 3/4 |
| 50 | 64-QAM | 16-QAM | 16-QAM | 3/4 |
| 51 | 64-QAM | 64-QAM | QPSK | 3/4 |
| 52 | 64-QAM | 64-QAM | 16-QAM | 3/4 |

For MCS 53-76, refer to related descriptions in the WLAN standard 802.11n. Details are not described herein again.

However, as a quantity of supported spatial streams increases and more MCS types are supported, entries in the table increase exponentially, and a large amount of storage and computing power needs to be consumed. Traversing each case in an index manner is obviously unrealistic.

In at least one embodiment, a user field is used to indicate a modulation scheme of each spatial stream (or each spatial stream group), and a quantity of user fields is adjusted based on a number of spatial streams (or spatial stream groups), so that modulation schemes of a plurality of spatial streams is indicated in a scenario of a plurality of spatial streams. Compared with a manner of traversing each case in an index manner, an implementation of at least one embodiment is relatively simple. In addition, some user fields do not include a station identifier subfield, a spatial stream indication subfield, or the like, so that the user field uses more bits to indicate a modulation scheme of a spatial stream. Compared with that the user field uses a fixed signaling format, each user field needs to indicate redundant information such as an identifier of a target station and spatial stream information. In at least one embodiment, bit utilization is improved, so that signaling overheads are reduced, and a throughput rate gain is improved.

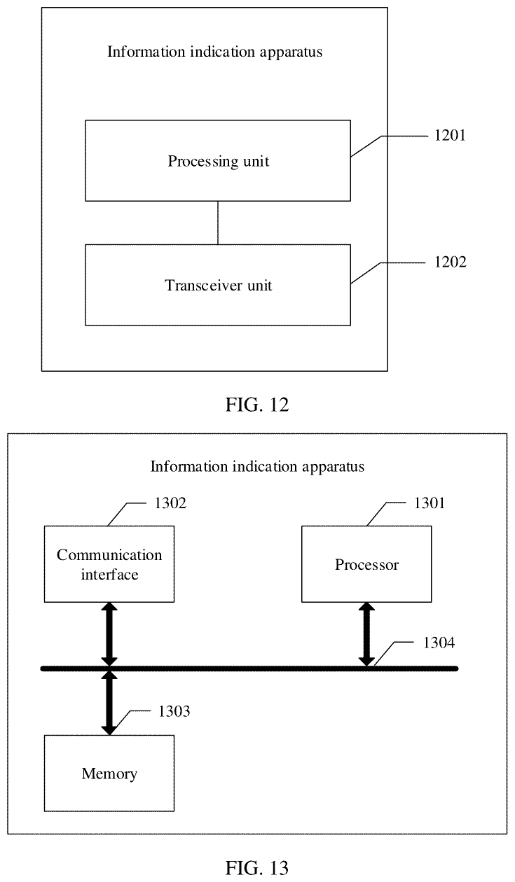

Based on a same technical concept as the method embodiments, at least one embodiment provides an information indication apparatus. A structure of the apparatus is shown in FIG. 12, including a processing unit 1201 and a transceiver unit 1202.

In an implementation, the information indication apparatus is specifically configured to implement the methods performed by the first device in the embodiments in FIG. 2 to FIG. 3, FIG. 4A, FIG. 4B, and FIG. 5 to FIG. 11. The apparatus is the first device, or is a chip, a chipset, or a part of a chip in the first device that is configured to perform a related method function. The first device is an AP, or is a STA. The processing unit 1201 is configured to generate a physical layer protocol data unit PPDU, where a first field in a signaling field of the PPDU is in a first value state, the first value state indicates that the PPDU carries vendor specific information, and the first value state is indicated by using one or more of the following states: any value state of a disregard bit, a non-default state of a validate bit, a disregard state, and a validate state. The transceiver unit 1202 is configured to send the PPDU.

For example, the first field includes a PPDU type and compression mode subfield and a non-OFDMA transmission user quantity subfield. The first value state is indicated by using the following validate state or disregard state: the PPDU type and compression mode subfield indicates single-user transmission, and the non-OFDMA transmission user quantity subfield indicates that a quantity of users participating in non-OFDMA transmission is greater than 1.

In at least one embodiment, the vendor specific information is modulation schemes of N spatial streams in an unequal modulation scheme, N is an integer greater than 1, and modulation schemes of at least two of the N spatial streams are different.

For example, the non-OFDMA transmission user quantity subfield indicates that a quantity of users is n, n is an integer, and 1<n≤N. The PPDU includes n user fields, where a 1^{st} user field in the n user fields indicates the total number N of the spatial streams, an identifier of a target station, and a modulation scheme of a 1^{st} spatial stream. 2^{nd} to n^{th} user fields indicate modulation schemes of 2^{nd} to N^{th} spatial streams.

For example, a station identifier subfield in the 1^{st} user field indicates the identifier of the target station. A spatial stream indication subfield in the 1^{st} user field indicates the total number N of the spatial streams. A modulation and coding scheme MCS indication subfield in the 1^{st} user field indicates the modulation scheme of the 1^{st} spatial stream.

For example, the first field includes a user field. The first value state is indicated by using the following validate state or disregard state. The second validate state is that a value of a station identifier subfield in the user field is a specific value.

Optionally, the vendor specific information is modulation schemes for N spatial streams in an unequal modulation scheme, N is an integer greater than 1, and modulation schemes of at least two spatial streams are different.

For example, the non-OFDMA transmission user quantity subfield indicates that the quantity of users is m, and m is an integer greater than 1. The N spatial streams are divided into H spatial stream groups, where H is an integer greater than 1. The PPDU includes m user fields. A first user field in the m user fields indicates the total quantity H of the spatial stream groups and a number of spatial streams in each of the H spatial stream groups. m−1 user fields in the m user fields other than the first user field indicate a modulation scheme of each of the H spatial stream groups.

Optionally, the first user field is a user field whose station identifier subfield has a specific value.

In another implementation, the information indication apparatus is specifically configured to implement the method performed by the second device in the embodiments. The apparatus is the second device, or is a chip, a chipset, or a part of a chip in the second device that is configured to perform a related method function. The second device is an AP, or is a STA. The transceiver unit 1202 is configured to receive a physical layer protocol data unit PPDU, where a first field in a signaling field of the PPDU is in a first value state, and the first value state is indicated by using one or more of the following states: any value state of a disregard bit, a non-default state of a validate bit, a disregard state, and a validate state. The processing unit 1201 is configured to: in response to a first transmission mechanism being supported, obtain vendor specific information from the PPDU, where the first transmission mechanism is that the first value state indicates that the PPDU carries the vendor specific information; or in response to a first transmission mechanism not being supported, process the PPDU by using the first value state as the validate state or the disregard.

For example, the first field includes a PPDU type and compression mode subfield and a non-OFDMA transmission user quantity subfield. The first value state is indicated by using the following validate state or disregard state: the PPDU type and compression mode subfield indicates single-user transmission, and the non-OFDMA transmission user quantity subfield indicates that a quantity of users participating in non-OFDMA transmission is greater than 1.

In at least one embodiment, the vendor specific information is modulation schemes of N spatial streams in an unequal modulation scheme, N is an integer greater than 1, and modulation schemes of at least two of the N spatial streams are different.

For example, the non-OFDMA transmission user quantity subfield indicates that a quantity of users is n, n is an integer, and 1<n≤N. The PPDU includes n user fields, where a 1^{st} user field in the n user fields indicates the total number N of the spatial streams, an identifier of a target station, and a modulation scheme of a 1^{st} spatial stream. 2^{nd} to n^{th} user fields indicate modulation schemes of 2^{nd} to N^{th} spatial streams.

For example, a station identifier subfield in the 1^{st} user field indicates the identifier of the target station. A spatial stream indication subfield in the 1^{st} user field indicates the total number N of the spatial streams. A modulation and coding scheme MCS indication subfield in the 1^{st} user field indicates the modulation scheme of the 1^{st} spatial stream.

For example, the first field includes a user field. The first value state is indicated by using the following validate state or disregard state. The second validate state is that a value of a station identifier subfield in the user field is a specific value.

Optionally, the vendor specific information is modulation schemes for N spatial streams in an unequal modulation scheme, N is an integer greater than 1, and modulation schemes of at least two spatial streams are different.

For example, the non-OFDMA transmission user quantity subfield indicates that the quantity of users is m, and m is an integer greater than 1. The N spatial streams are divided into H spatial stream groups, where H is an integer greater than 1. The PPDU includes m user fields. A first user field in the m user fields indicates the total quantity H of the spatial stream groups and a number of spatial streams in each of the H spatial stream groups. m−1 user fields in the m user fields other than the first user field indicate a modulation scheme of each of the H spatial stream groups.

Optionally, the first user field is a user field whose station identifier subfield has a specific value.

Division into the modules in at least one embodiment is an example, is merely division into logical functions, and is other division during actual implementation. In addition, functional modules in at least one embodiment is integrated into one processor, or each of the modules exist alone physically, or two or more modules are integrated into one module. The integrated module is implemented in a form of hardware, or is implemented in a form of a software functional module. For functions or implementations of the modules in at least one embodiment, further refer to related descriptions in the method embodiments.

In at least one embodiment, the information indication apparatus is shown in FIG. 13. The apparatus is a communication device or a chip in a communication device. The communication device is the first device, or is the second device. The first device is an AP or a STA, and the second device is an AP or a STA. The apparatus includes a processor 1301, a communication interface 1302, and a memory 1303. The processing unit 1201 is the processor 1301. The transceiver unit 1202 is the communication interface 1302.

The processor 1301 is a central processing unit (central processing unit, CPU), a digital processing unit, or the like. The communication interface 1302 is a transceiver, an interface circuit such as a transceiver circuit, a transceiver chip, or the like. The apparatus further includes a memory 1303, configured to store a program executed by the processor 1301. The memory 1303 is a nonvolatile memory such as a hard disk drive (hard disk drive, HDD) or a solid-state drive (solid-state drive, SSD), or is a volatile memory (volatile memory) such as a random access memory (random access memory, RAM). The memory 1303 is any other medium capable of carrying or storing expected program code in a form of instructions or data structures and capable of being accessed by a computer, but is not limited thereto.

The processor 1301 is configured to execute the program code stored in the memory 1303, and is specifically configured to perform an action of the processing unit 1201. Details are not described herein again in at least one embodiment. The communication interface 1302 is specifically configured to perform an action of the transceiver unit 1202. Details are not described again.

A specific connection medium between the communication interface 1302, the processor 1301, and the memory 1303 is not limited in at least one embodiment. In at least one embodiment, the memory 1303, the processor 1301, and the communication interface 1302 are connected to each other through a bus 1304 in FIG. 13. The bus is represented by using a bold line in FIG. 13. A connection manner between other components is merely an example for description, and is not limited thereto. The bus is classified into an address bus, a data bus, a control bus, and the like. For ease of representation, only one bold line is used to represent the bus in FIG. 13, but this does not mean that there is only one bus or only one type of bus.

An embodiment of the present invention further provides a computer-readable storage medium, configured to store computer software instructions that need to be executed by the foregoing processor, and the computer-readable storage medium includes a program that needs to be executed by the foregoing processor.

All or some of the foregoing embodiments is implemented by using software, hardware, firmware, or any combination thereof. In response to software being used to implement the embodiments, all or a part of the embodiments is implemented in a form of a computer program product. The computer program product includes one or more computer instructions. In response to the computer program instructions being loaded and executed on the computer, the procedure or functions according to at least one embodiment are all or partially generated. The computer is a general-purpose computer, a dedicated computer, a computer network, or other programmable apparatuses. The computer instructions are stored in a computer-readable storage medium or are transmitted from a computer-readable storage medium to another computer-readable storage medium. For example, the computer instructions are transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium is any usable medium accessible by a computer, or a data storage device, such as a server or a data center, integrating one or more usable media. The usable medium is a magnetic medium (for example, a floppy disk, a hard disk, or a magnetic tape), an optical medium (for example, a DVD), or a semiconductor medium (for example, an SSD).

At least one embodiment is described with reference to the flowcharts and/or block diagrams of the method, the device (system), and the computer program product according to this application. Computer program instructions are used to implement each process and/or each block in the flowcharts and/or the block diagrams and a combination of a process and/or a block in the flowcharts and/or the block diagrams. These computer program instructions are provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions is stored in a computer-readable memory that instructs the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

The computer program instructions are alternatively loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

A person skilled in the art is able to make various modifications and variations without departing from the spirit and scope of embodiments described herein. At least one embodiment is intended to cover these modifications and variations provided that they fall within the scope of protection defined by the following claims and their equivalent technologies.

What is claimed is:

1. An information indication method, comprising:
generating, by a first device, a physical layer protocol data unit (PPDU), wherein a first field in a signaling field of the PPDU is in a first value state, the first value state indicates that the PPDU carries vendor specific information, and the first value state is indicated by using one or more of the following states: any value state of a disregard bit, a non-default state of a validate bit, a disregard state, and a validate state; and
sending, by the first device, the PPDU.

2. The method according to claim 1, wherein the first field comprises a PPDU type and compression mode subfield and a non-orthogonal frequency division multiple access (OFDMA) transmission user quantity subfield; and
the first value state is indicated by using the following validate state or disregard state: the PPDU type and compression mode subfield indicates single-user transmission, and the non-OFDMA transmission user quantity subfield indicates that a quantity of users participating in non-OFDMA transmission is greater than 1.

3. The method according to claim 2, wherein the vendor specific information is modulation schemes of N spatial streams in an unequal modulation scheme, N is an integer greater than 1, and modulation schemes of at least two of the N spatial streams are different.

4. The method according to claim 3, wherein the non-OFDMA transmission user quantity subfield indicates that the quantity of users is n, n is an integer, and 1<n≤N; and
the PPDU comprises n user fields, wherein a 1^{st} user field in the n user fields indicates a total number N of the spatial streams, an identifier of a target station, and a modulation scheme of a 1^{st} spatial stream, and 2^{nd} to n^{th} user fields indicate modulation schemes of 2^{nd} to N^{th} spatial streams.

5. The method according to claim 4, wherein a station identifier subfield in the 1^{st} user field indicates the identifier of the target station, a spatial stream indication subfield in the 1^{st} user field indicates the total number N of the spatial streams, and a modulation and coding scheme MCS indication subfield in the 1^{st} user field indicates the modulation scheme of the 1^{st} spatial stream.

6. The method according to claim 1, wherein the first field comprises a user field; and
the first value state is indicated by using the following validate state or disregard state: a value of a station identifier subfield of the user field is a specific value.

7. The method according to claim 6, wherein the vendor specific information is modulation schemes of N spatial streams in an unequal modulation scheme, N is an integer greater than 1, and modulation schemes of at least two spatial streams are different.

8. The method according to claim 3, wherein the non-OFDMA transmission user quantity subfield indicates that the quantity of users is m, and m is an integer greater than 1; and
the N spatial streams are divided into H spatial stream groups, wherein H is an integer greater than 1, the PPDU comprises m user fields, a 1^{st} user field in the m user fields indicates a total quantity H of the spatial stream groups and a number of spatial streams in each of the H spatial stream groups, m−1 user fields in the m user fields other than the 1^{st} user field indicate a modulation scheme of each of the H spatial stream groups.

9. An information indication apparatus, comprising:
a memory configured to store computer-executable instructions; and
a processor coupled to the memory, wherein the processor is configured to execute the computer-executable instructions stored in the memory to:
generate a physical layer protocol data unit (PPDU), wherein a first field in a signaling field of the PPDU is in a first value state, the first value state indicates that the PPDU carries vendor specific information, and the first value state is indicated by using one or more of the following states: any value state of a disregard bit, a non-default state of a validate bit, a disregard state, and a validate state; and
send the PPDU.

10. The apparatus according to claim 9, wherein the first field comprises a PPDU type and compression mode subfield and a non-orthogonal frequency division multiple access (OFDMA) transmission user quantity subfield; and
the first value state is indicated by using the following validate state or disregard state: the PPDU type and compression mode subfield indicates single-user transmission, and the non-OFDMA transmission user quantity subfield indicates that a quantity of users participating in non-OFDMA transmission is greater than 1.

11. The apparatus according to claim 10, wherein the vendor specific information is modulation schemes of N spatial streams in an unequal modulation scheme, N is an integer greater than 1, and modulation schemes of at least two of the N spatial streams are different.

12. The apparatus according to claim 11, wherein the non-OFDMA transmission user quantity subfield indicates that the quantity of users is n, n is an integer, and 1<n≤N; and
the PPDU comprises n user fields, wherein a 1^{st} user field in the n user fields indicates a total number N of the spatial streams, an identifier of a target station, and a modulation scheme of a 1^{st} spatial stream, and 2^{nd} to n^{th} user fields indicate modulation schemes of 2^{nd} to N^{th} spatial streams.

13. The apparatus according to claim 12, wherein a station identifier subfield in the 1^{st} user field indicates the identifier of the target station, a spatial stream indication subfield in the 1^{st} user field indicates the total number N of the spatial streams, and a modulation and coding scheme MCS indication subfield in the 1^{st} user field indicates the modulation scheme of the 1^{st} spatial stream.

14. The apparatus according to claim 9, wherein the first field comprises a user field; and
the first value state is indicated by using the following validate state or disregard state: a value of a station identifier subfield of the user field is a specific value.

15. The apparatus according to claim 14, wherein the vendor specific information is modulation schemes of N spatial streams in an unequal modulation scheme, N is an integer greater than 1, and modulation schemes of at least two spatial streams are different.

16. The apparatus according to claim 11, wherein the non-OFDMA transmission user quantity subfield indicates that the quantity of users is m, and m is an integer greater than 1; and
the N spatial streams are divided into H spatial stream groups, wherein H is an integer greater than 1, the PPDU comprises m user fields, a 1^{st} user field in the m user fields indicates a total quantity H of the spatial stream groups and a number of spatial streams in each of the H spatial stream groups, m−1 user fields in the m user fields other than the 1^{st} user field indicate a modulation scheme of each of the H spatial stream groups.

17. A non-transitory computer-readable storage medium, wherein the non-transitory computer-readable storage medium stores a program or instructions, and when the program or the instructions are read and executed by one or more processors, cause the one or more processors to:
generate a physical layer protocol data unit (PPDU), wherein a first field in a signaling field of the PPDU is in a first value state, the first value state indicates that the PPDU carries vendor specific information, and the first value state is indicated by using one or more of the following states: any value state of a disregard bit, a non-default state of a validate bit, a disregard state, and a validate state; and
send the PPDU.

18. The non-transitory computer-readable storage medium according to claim 17, wherein the first field comprises a PPDU type and compression mode subfield and a non-orthogonal frequency division multiple access (OFDMA) transmission user quantity subfield; and
the first value state is indicated by using the following validate state or disregard state: the PPDU type and compression mode subfield indicates single-user transmission, and the non-OFDMA transmission user quantity subfield indicates that a quantity of users participating in non-OFDMA transmission is greater than 1.

19. The non-transitory computer-readable storage medium according to claim 18, wherein the vendor specific information is modulation schemes of N spatial streams in an unequal modulation scheme, N is an integer greater than 1, and modulation schemes of at least two of the N spatial streams are different.

20. The non-transitory computer-readable storage medium according to claim 19, wherein the non-OFDMA transmission user quantity subfield indicates that the quantity of users is n, n is an integer, and 1<n≤N; and
the PPDU comprises n user fields, wherein a 1^{st} user field in the n user fields indicates a total number N of the spatial streams, an identifier of a target station, and a modulation scheme of a 1^{st} spatial stream, and 2^{nd} to n^{th} user fields indicate modulation schemes of 2^{nd} to N^{th} spatial streams.
